(19) United States
(12) Patent Application Publication
(10) Pub. No.: US 2026/0201207 A1
(43) Pub. Date: Jul. 16, 2026

(54) COATING COMPOSITIONS, ARTICLES, AND METHODS OF COATING

(71) Applicant: SWIMC LLC, Cleveland, OH (US)

(72) Inventors: Philippe MICHEL, Cleveland, OH (US); Floraine COLLETTE, Cleveland, OH (US); Christine BEAUFRETON, Gorges (FR); Adeline GUIDAL, Orvault (FR); Amandine DEQUIDT, Nantes (FR); Melanie FONTAINE, Reze (FR); Delphine DESTAL, Bouaye (FR); Clementine MAURIER, Nantes (FR); Jean-Dominique TURGIS, Vertou (FR); Sebastien GIBANEL, Givry (FR); Matthieu ANDRIOT, Attignat (FR)

(21) Appl. No.: 19/134,010

(22) PCT Filed: Dec. 8, 2023
(86) PCT No.: PCT/US2023/083148

§ 371 Date: May 29, 2025

Related U.S. Application Data
(60) Provisional application No. 63/386,713, filed on Dec. 9, 2022.

(51) Int. Cl. C09D 175/06; B05D 3/02; C08G 18/42; C08G 18/80; C08K 3/22; C09D 7/20; C09D 7/61

(52) U.S. Cl. CPC C09D 175/06; B05D 3/0272; C08G 18/4213; C08G 18/8074; C08K 3/22; C09D 7/20; C09D 7/61; B05D 2202/15; B05D 2202/25; B05D 2259/00; B05D 2401/10; B05D 2503/00; B05D 2601/24; C08K 2003/2241

(57) ABSTRACT

The present disclosure relates to food or beverage container coating compositions, articles having a coating formed from such compositions, and methods of coating using the compositions to achieve performance in multiple properties at the same time when using select blocked polyisocyanate crosslinkers combined with select hydroxyl-functional polyester polymers. The selected combinations of the blocked polyisocyanate and hydroxyl-functional polyester polymers provide the robust ability to use a wider variety of hydroxyl-functional polyester polymers in terms of peak molecular weight and glass transition temperature to achieve acceptable and/or enhanced performance in terms of plate aging, flow lines, and acid retort performance, while the freedom to use a broader range of concentrations of isocyanate is maintained.

### CROSS-REFERENCE TO RELATED APPLICATIONS

This application claims the benefit of priority under 35 U.S.C. § 119 to U.S. Provisional Application No. 63/386,713, filed on Dec. 9, 2022, which is incorporated herein by reference in its entirety.

### FIELD

The present application relates to coating compositions, articles including such coating compositions, and methods of coating articles with the coating compositions.

### BACKGROUND

The balance of coating performance attributes required for a coating composition to be suitable for use as a food or beverage container coating are particularly stringent and are unique from other coating end uses. As such, coatings designed for other end uses are not typically suitable for use as food or beverage container coatings.

For example, coatings for use on food or beverage containers should avoid unsuitably altering the taste of the packaged food or beverage products, and should also avoid flaking or chipping into the packaged products. The coatings should also resist chemically aggressive food or beverage products (which can have a complex chemical profile, including salts, acids, sugars, fats, etc.) for extended periods of time (e.g., years). Food or beverage container coatings should also have good adhesion to the underlying substrate and remain sufficiently flexible after curing. This is because subsequent fabrication and denting during transportation, storage, or use (e.g., by dropping) may cause the metal substrate to deform, which will cause the coating to flex. A brittle coating will crack during flexure, exposing the container metal to the packaged products, which can sometimes cause a leak in the container. Even a low probability of coating failure may cause a significant number of containers to leak, given the high number of food and beverage containers produced.

Various coatings have been used as protective food or beverage container coatings, including epoxy coatings and polyvinyl-chloride-based coatings. Each of these coating types, however, has potential shortcomings. For example, the recycling of materials containing polyvinyl chloride or related halide-containing vinyl polymers can be problematic. There is also a desire by some to reduce or eliminate certain epoxy compounds (e.g., bisphenol A) commonly used to formulate food-contact epoxy coatings. Although a number of replacement coating compositions made without such materials have been proposed, some replacement compositions have exhibited insufficient coating properties such as insufficient corrosion resistance on metal substrates, insufficient flexibility, or insufficient toughness.

To address the aforementioned shortcomings, the packaging coatings industry has sought coatings based on alternative binder systems such as polyester resin systems, for example. It has been problematic, however, to formulate polyester-based coatings that exhibit the required balance of coating characteristics (e.g., flexibility, adhesion, corrosion resistance, stability, resistance to crazing, etc.). For example, there has typically been a tradeoff between corrosion resistance and fabrication properties for such coatings. Polyester-based coatings suitable for food-contact that have exhibited both good fabrication properties and an absence of crazing have tended to be too soft and exhibit unsuitable corrosion resistance. Conversely, polyester-based coatings suitable for food contact that have exhibited good corrosion resistance have typically exhibited poor flexibility and unsuitable crazing when fabricated.

### SUMMARY

The present disclosure provides food or beverage container coating compositions, articles having a coating formed from such compositions, and methods of coating. Herein, a food or beverage “container” is used to encompass containers such as pails or drums in addition to conventional metal cans.

In one embodiment, a food or beverage container coating composition suitable for coating, at least a portion of, an inner side of a food or beverage container is described herein. In one aspect, the food or beverage container coating composition includes at least (1) a hydroxyl-functional polyester polymer and (2) at least one blocked polyisocyanate crosslinker. In some embodiments, the hydroxyl-functional polyester polymer has a glass transition temperature (Tg) of 20° C. or higher, as determined by differential scanning calorimetry (DSC). In other embodiments, the blocked polyisocyanate crosslinker has, on average, at least two primary isocyanate groups per molecule; and/or the blocked polyisocyanate crosslinker has, on average, more than 50 mole percent of the isocyanate groups present on the at least one blocked polyisocyanate crosslinker being primary isocyanate groups; and/or the blocked polyisocyanate crosslinker is a reaction product of ingredients including a diisocyanate having two primary isocyanate groups.

In yet other embodiments, food or beverage container coating composition of the preceding paragraph may be combined with one or more other embodiments or features in any combination. These other embodiments or features may include one or more of the following: wherein the hydroxyl-functional polyester polymer has, on average, at least 1.8 hydroxyl groups per molecule, at least 1.9 hydroxyl groups per molecule, and preferably at least about 2 hydroxyl groups per molecule; and/or wherein the at least one blocked polyisocyanate crosslinker includes three or more blocked isocyanate groups; and/or wherein the at least one blocked polyisocyanate crosslinker is a reaction product of ingredients including one or more of hexamethylene diisocyanate (HDI), 1,4-diisocyanatobutane, pentamethylene diisocyanate, 1,12-diisocyanatododecaneor, or one or more other diisocyanates selected from OCN—CH₂—R—CH₂—NCO wherein R is any branched or unbranched hydrocarbon chain; and/or wherein the at least one blocked polyisocyanate crosslinker is a reaction product of ingredients including hexamethylene diisocyanate (HDI); and/or wherein the at least one blocked polyisocyanate crosslinker comprises an isocyanate trimer; and/or wherein the at least one blocked polyisocyanate crosslinker comprises a blocked hexamethylene diisocyanate isocyanurate trimer; and/or wherein the at least one blocked polyisocyanate crosslinker is prepared using a cyclic ester, preferably a lactone such as ε-caprolactam as the only blocking agent, and wherein preferably at least about 95% of the isocyanate groups are blocked with a cyclic ester, preferably a lactone such as ε-caprolactam; and/or wherein the at least one blocked polyisocyanate crosslinker has a number average molecular weight (Mn) of less than about 2,000 g/mol, less than about 1,500 g/mol, less than about 1,200 g/mol, less than about 1,000 g/mol, or less than about 950 and, preferably, the blocked polyisocyanate crosslinker has a Mn of at least about 850 g/mol; and/or wherein the coating composition, based on total solids weight, includes at least about 1%, at least about 5%, at least about 7.5%, at least about 10%, or at least about 15% by weight of the at least one blocked polyisocyanate crosslinker; and/or wherein the coating composition, based on total solids weight, includes less than about 40%, less than about 30%, less than about 25%, or less than about 20% by weight of the at least one blocked polyisocyanate crosslinker; and/or wherein the polyester polymer has a peak molecular weight (Mp), as determined by GPC using polystyrene standards, of at least at least about 15,000 to less than about 30,000; and/or wherein the polyester polymer has a hydroxyl value of more than about 5 to less than about 50 mg KOH/g resin, at least about 10 to no more than 30 mg KOH/g resin, or at least about 15 to no more than about 35 mg KOH/g resin; and/or wherein the polyester polymer has an acid value, if any, of less than 20, less than 10, less than 5, less than 3, less than 2, or less than 1 mg KOH/g resin; and/or wherein the polyester polymer has a glass transition temperature (Tg) of at least about 30° C. as determined by differential scanning calorimetry (DSC); and/or wherein the polyester polymer has a glass transition temperature (Tg) of from at least about 40° C. to less than about 100° C.; and/or wherein the polyester polymer includes backbone aromatic groups (e.g., one or more backbone aromatic groups present in one or more structural units derived from phthalic acid, terephthalic acid, isophthalic acid, 2,5-furandicarboxylic acid, an anhydride or ester thereof, or combination thereof); and/or wherein the polyester polymer is formed from reactants including: (i) a polyacid (preferably a diacid), anhydride, dianhydrides, acid/anhydrides, or alkyl ester thereof and (ii) a polyol (preferably a diol), wherein (i) includes at least one aromatic compound; and/or wherein the reactants include phthalic acid, terephthalic acid, isophthalic acid, 2,5-furandicarboxylic acid, naphthalene dicarboxylic acid (e.g., 2,6-napthalene dicarboxylic acid), a derivative thereof (e.g., an anhydride or alkyl ester thereof), or a mixture thereof; and/or wherein the coating composition, based on total resin solids, includes at least about 30, at least about 40, at least about 50, at least about 60, at least about 70, at least about 80, or at least about 90% by weight of the polyester polymer; and/or wherein the coating composition is a solvent-based coating composition that preferably includes less than 2% by weight of water, if any; and/or wherein the coating composition includes an inorganic pigment in an amount of at least 5% by weight of the coating composition, based on total coating solids; and/or wherein the inorganic pigment comprises titanium dioxide; and/or wherein the coating composition is an organic-solvent-based, interior white three-piece food or beverage container coating composition; and/or wherein the coating composition includes at least about 25 percent, at least about 30 percent, or at least about 35 percent by weight of total coating solids and up to about 70 percent, up to about 60 percent, or up to about 55 percent by weight of total coating solids; and/or wherein the at least one blocked polyisocyanate crosslinker constitutes more than 50% by weight of the total amount of crosslinker present in the coating composition; and/or wherein the coating composition includes an additional blocked isocyanate crosslinker that is a reaction product of IPDI; and/or wherein the coating composition is not made using any crosslinkers derived from formaldehyde; and/or wherein the coating composition, when applied on tin-plate steel can stock substrate and baked for 15 minutes in a 200° C. oven to achieve a cured coating having an average dry film weight of about 15 grams per square meter, exhibits an MEK double rub value in the MEK test described herein (using a 1,000 gram weight) of at least about 30, at least about 35, at least about 40, at least about 60, at least about 80, or at least about 100 and, preferably, the coating composition also exhibits such MEK double rub values when using a 2,000 gram weight; and/or wherein the coating composition, when applied on tin-plate steel can stock substrate and baked for 15 minutes in a 200° C. oven to achieve a cured coating having an average dry film weight of about 15 grams per square meter, passes an electric current (after end formation) of less than about 10 milliamps (mA) when tested as described herein in the Plate Aging Test, more preferably less than 5 mA, even more preferably less than 2 mA, after aging for at least about 3 days, and more preferably at least about 7 days at 20 to 25° C.; and/or wherein the coating composition, when applied on tin-plate steel can stock substrate and baked for 15 minutes in a 200° C. oven to achieve a cured coating having an average dry film weight of about 15 grams per square meter and stamped without aging into regular food can ends, has an average crack length of less than about 200 microns, preferably, less than about 100 microns, more preferably, less than about 50 microns, if any, of visible cracks when tested pursuant to the Flow Lines test method described herein; and/or wherein the coating composition, when applied on tin-plate steel can stock substrate formed into a can end and baked for 15 minutes in a 200° C. oven to achieve a cured coating having an average dry film weight of about 15 grams per square meter, passes an electric current (after end formation) of less than about 10 milliamps (mA), less than about 5 milliamps (mA), more preferably less than 4 mA, even more preferably less than 2 mA when tested as described herein in the Acid Retort test, after subjecting the coated substrate to retort conditions of 1 hour at 130° C. in direct contact with a liquid solution of 3% acetic acid; and/or wherein the food or beverage container coating composition forms a coating that includes less than 50 ppm extractables, if any, when tested pursuant to the Global Extraction Test.

In another embodiment, a method of applying a food or beverage container coating composition of any previous embodiment of this Summary to a metal substrate is also described herein and wherein the method further cures the coating composition on the metal substrate to form a coating; and the method further optionally fabricates the metal substrate having the coating to form a food or beverage container or a portion thereof.

In yet another embodiment, a method of optionally preparing the food or beverage container coating composition of any embodiment of this Summary and then causing the food or beverage container coating composition of any embodiment of this Summary to be disposed on a food container or a portion thereof, more preferably, an interior portion of the food or beverage container.

In yet a further embodiment, an article comprising a food or beverage container or portion thereof that includes a metal substrate (e.g., a metal sheet such as a steel or tinplate sheet) and a coating disposed on at least a portion of the metal substrate where the coating is formed from a coating composition of any embodiment of this Summary.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### Selected Definitions

Unless otherwise specified or apparent from the context, the following terms as used herein have the meanings provided below.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., includes, comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other claims are not useful, and is not intended to exclude other embodiments from the scope of the disclosure.

As used herein, the term “room temperature” refers to a temperature of about 20° C. to about 25° C.

The terms “solids” and “non-volatile content” are used interchangeably, herein. Thus, for example, the total solids and the total non-volatile content (“NVC” or “NVM”) of a given composition are the same. By way of example, the total solids of a liquid composition can be determined by volatilizing off the volatile content of the liquid coating composition, with the percent solids of the liquid composition being the weight percentage of the remaining non-volatile content relative to the initial starting weight.

Any number average molecular weight (Mn) disclosed herein can be determined by Gel Permeation Chromatography (GPC), measured against a set of polystyrene standards of varying molecular weights. Peak molecular weight (Mp) disclosed herein can also be determined by Gel Permeation Chromatography (GPC), measured against a set of polystyrene standards of varying molecular weights, where Mp is taken as the location of the peak of the distribution of all molecular weights.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

As used herein, the term “organic group” means a hydrocarbon group (with optional elements other than carbon and hydrogen, such as oxygen, nitrogen, sulfur, and silicon) that is classified as an aliphatic group, cyclic group, or combination of aliphatic and cyclic groups (e.g., alkaryl and aralkyl groups). The term “aliphatic group” means a saturated or unsaturated linear or branched hydrocarbon group. This term is used to encompass alkyl, alkenyl, and alkynyl groups, for example. The term “alkyl group” means a saturated linear or branched hydrocarbon group including, for example, methyl, ethyl, isopropyl, t-butyl, heptyl, dodecyl, octadecyl, amyl, 2-ethylhexyl, and the like. The term “alkenyl group” means an unsaturated, linear or branched hydrocarbon group with one or more carbon-carbon double bonds, such as a vinyl group. The term “cyclic group” means a closed ring hydrocarbon group that is classified as an alicyclic group or an aromatic group, both of which can include heteroatoms.

A group that may be the same or different is referred to as being “independently” something. Substitution is anticipated on the organic groups of the compounds of the present disclosure. As a means of simplifying the discussion and recitation of certain terminology used throughout this application, the terms “group” and “moiety” are used to differentiate between chemical species that allow for substitution or that may be substituted and those that do not allow or may not be so substituted. Thus, when the term “group” is used to describe a chemical substituent, the described chemical material includes the unsubstituted group and that group with O, N, Si, or S atoms, for example, in the chain (as in an alkoxy group) as well as carbonyl groups or other conventional substitution. Where the term “moiety” is used to describe a chemical compound or substituent, only an unsubstituted chemical material is intended to be included. For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc. Thus, “alkyl group” includes ether groups, haloalkyls, nitroalkyls, carboxyalkyls, hydroxyalkyls, sulfoalkyls, etc. On the other hand, the phrase “alkyl moiety” is limited to the inclusion of only pure open chain saturated hydrocarbon alkyl substituents, such as methyl, ethyl, propyl, t-butyl, and the like.

The term “component” refers to any compound that includes a particular feature or structure. Examples of components include compounds, monomers, oligomers, polymers, and organic groups contained there.

The term “ethylenically unsaturated” refers to compounds that include a non-aromatic carbon-carbon double bond (i.e. —C═C—), with vinylic double bonds being preferred.

The term “mobile” means that the compound can be extracted from the cured coating when a coating (typically about 1 milligram per square centimeter (mg/cm²) (6.5 mg/in²) thick) is exposed to a test medium for some defined set of conditions, depending on the end use. An example of these testing conditions is exposure of the cured coating to HPLC-grade acetonitrile for 24 hours at 25° C.

The term “food-contact surface” refers to a surface of an article (e.g., a food or beverage container) that is in contact with, or suitable for contact with, a food or beverage product. When used in the context of a coating composition applied on a food-contact surface of a packaging article (e.g., a food or beverage container), the term refers to the underlying substrate (typically associated with an interior surface of the packaging article) on which the coating composition is applied and does not imply that the underlying portion of the substrate will be in contact with a food or beverage product.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate.

Unless otherwise indicated, the terms “polymer” and “polymeric material” include, but are not limited to, homopolymers, copolymers (such as for example, block, graft, random or statistical and alternating copolymers, terpolymers, etc.), and blends and modifications thereof. Furthermore, unless otherwise specifically limited, the term “polymer” shall include all possible geometrical configurations of the material. These configurations include, but are not limited to, isotactic, syndiotactic, and atactic symmetries. In general, polymers have number average molecular weights of about 1,000 g/mol or greater. As also used herein, “oligomers” refer to lower molecular weight polymers and, in general, have a number average molecular weight of less than about 1,000 g/mol. As used herein, the term “resin” or “resins” refers to compositions including both polymers and/or oligomers.

The term “monomer constituent unit” refers to a structural unit resulting from polymerization of monomers. As used herein, “monomer” or reactant generally refers to a compound within a reaction mixture prior to polymerization and monomer units or (alternatively) structural units refers to the monomer or reactant within the polymer. If the discussion herein refers to a monomer or reactant, it also implies the resultant monomer unit or structural unit thereof in the polymer. Likewise, if the discussion refers to a monomer unit or structural unit, it also implies the monomer or reactant mixture used to form the polymer with the associated units therein.

The term “unsaturation” when used in the context of a compound refers to a compound that includes at least one non-aromatic carbon-carbon double or triple bond.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “or” is generally employed in its usual sense including “and/or” unless the content clearly dictates otherwise.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DRAWING FIGURES

FIG. 1 is a radar chart of comparative compositions using IPDI-based blocked polyisocyanate crosslinkers showing the limited selection of hydroxyl-functional polyester polymers available in terms of peak molecular weight, glass transition temperature, and isocyanate equivalent weight in order to achieve acceptable plate aging, flow lines, and acid retort performance; and

FIG. 2 is a radar chart of inventive compositions using HDI-based blocked polyisocyanate crosslinkers showing the robust ability to use a wider variety of hydroxyl-functional polyester polymers in terms of peak molecular weight, glass transition temperature, and isocyanate equivalent weight to achieve acceptable and/or enhanced plate aging, flow lines, and acid retort performance.

### DETAILED DESCRIPTION

The present disclosure provides food or beverage container coating compositions, articles having a coating formed from such compositions, methods of coating, and methods of causing the coatings herein. In preferred embodiments, the coating composition is a polyester-based coating composition that includes a hydroxyl-functional polyester and, in some embodiments, the hydroxyl-functional polyester has a glass transition temperature (Tg) of at least about 20° C. In other embodiments, the coating composition also includes at least one blocked polyisocyanate crosslinker. In one aspect, the blocked polyisocyanate crosslinker has, on average, at least two primary isocyanate groups per molecule; and/or the blocked polyisocyanate crosslinker has, on average, more than 50 mole percent of the isocyanate groups present on the at least one blocked polyisocyanate crosslinker being primary isocyanate groups; and/or the blocked polyisocyanate crosslinker is a reaction product of ingredients including a diisocyanate having two primary isocyanate groups. The term “blocked” when used in the context of a blocked isocyanate groups refers to an isocyanate group that has been protected with a blocking agent to avoid premature consumption of the isocyanate group prior to thermal cure, where the blocked isocyanate group becomes available (e.g., via the blocking agent disassociating from the protected isocyanate group) for participating in crosslinking during thermal cure conditions frequently employed to cure food or beverage container coating compositions (e.g., oven baking temperatures of from 170° C. to 230° C.). Unless indicated otherwise, the term “isocyanate group” encompasses both free isocyanate groups and blocked isocyanate groups. The term “blocked” when used in the context of a blocked polyisocyanate crosslinker refers to a polyisocyanate crosslinker having two or more isocyanate groups, where at least some of the isocyanate groups are blocked isocyanate groups. Preferably the vast majority of the isocyanate groups present in the blocked polyisocyanate crosslinker are blocked isocyanate groups, and more preferably substantially all (e.g., >95%, preferably >99%, more preferably greater than 99.9%).

### Polyester Polymer

The polyester polymer is hydroxyl-functional and, in some embodiments, the hydroxyl-functional polyester polymer has, on average, at least 1.8 hydroxyl groups per molecule, at least 1.9 hydroxyl groups per molecule, and preferably at least about 2 hydroxyl groups per molecule. In preferred embodiments, suitable polyester polymers herein also have a peak molecular weight (Mp), as determined by gel permeation chromatography (GPC) using polystyrene standards, of less than about 30,000, less than about 29,000, less than about 28,000, less than about 27,000, less than about 26,000, less than about 25,000, less than about 24,000, less than about 23,000, less than about 22,000, less than about 21,000, or less than about 20,000. The polyester polymers herein also preferably have a peak molecular weight (Mp) of at least at least about 15,000, at least about 16,000, at least about 17,000, at least about 18,000, at least about 19,000, at least about 20,000, at least about 21,000, at least about 22,000, or at least 23,000. In some approaches, the polyester polymer can exhibit any suitable polydispersity index (PDI), which can be calculated based on the determined weight-average molecular weight (Mw) and the Mn. That is, PDI is Mw/Mn. In preferred embodiments, the polyester polymer has a PDI of no more than about 5, no more than about 4, no more than about 3.5, or no more than about 3. While the minimum PDI value is not restricted, typically it will be at least about 1.5, at least about 1.75, at least about 2, or at least about 2.25. Similar to Mp noted above, Mn and Mw can be determined via GPS using polystyrene standards.

The polyester polymer of the present disclosure can have any suitably backbone configuration. Depending on the embodiment, the polymer can be linear (e.g., not formed via reactants including a branching compound), substantially linear, or branched (e.g., formed via reactants including a branching compound having three of more reactive functional groups, preferably three or more reactive functional groups capable of participating in an esterification or transesterification reaction). Similarly, the polyester polymer can be saturated or unsaturated. Typically, the backbone of the polyester polymer includes a plurality of aromatic groups. In some optional approaches, the hydroxyl-functional polyester polymer does not include polycyclic cycloaliphatic groups (e.g., does not include any structural units derived from tricyclodecanedimethanol).

In preferred embodiments, at least one end of the backbone of the polyester polymer of the present disclosure is hydroxyl-terminated. More preferably, the backbone is terminated on each end with a hydroxyl group, where at least one, and more preferably both, of the hydroxyl groups are primary hydroxyl groups. The polyester polymer may also, or alternatively, include one or more, or a plurality, of hydroxyl groups located at non-terminal locations of the polymer backbone (e.g., as pendant groups). Preferably, on average, the polyester polymer includes at least about 1.8 hydroxyl groups per molecule, at least about 1.9 hydroxyl groups per molecule, and preferably at least about 2 hydroxyl groups per molecule. In some embodiments, the polyester polymer includes hydroxyl groups at each terminal ends of the backbone and, in addition, includes at least one hydroxyl group in a side chain. While not intending to be bound by theory, it is believed that in some embodiments both (i) the presence of more than two hydroxyl group and (ii) the presence of one or more intermediate hydroxyl groups (i.e., at locations other than the terminal ends of the polymer backbone) can enhance reactivity and ultimately coating properties. Moreover, for purposes of reactivity, the use of primary hydroxyl groups are preferred.

The hydroxyl value (also called “hydroxyl number”) of the polyester polymer may be determined using the test method disclosed later herein. In preferred embodiments, the polyester has a hydroxyl value of at least 5, at least 8, at least 10, at least 11, at least 12, at least 13, at least 14, more preferably at least 15, at least 16, at least 17, at least 18, at least 19, at least 20, at least 21, at least 22, at least 23, at least 24, at least 25, at least 26, or at least 27 milligrams (mg) KOH per gram (g) resin. While the maximum value for the hydroxyl value is not particularly restricted, due to, for example, molecular weight considerations, it will typically be less than 100, less than 80, less than 60, less than 50, less than 45, less than 40, less than 35, less than 30, less than 25, less than 20, less than 15, or less than 10 mg KOH/g resin.

The polyester polymer of the present disclosure may have any suitable acid value (also referred to as “acid number”). However, to achieve the desired hydroxyl value, typically the polyester will exhibit an acid value, if any, of less than 20, less than 10, less than 5, less than 3, less than 2, or less than 1 mg KOH/g resin. In certain preferred embodiments, the acid number is less than 5 mg KOH/g resin, preferably less than 3 mg KOH/g resin.

When used to formulate an interior food or beverage container coating composition, and especially for coatings intended for use in packaging so called “hard-to-hold” products, the polyester polymer preferably exhibits a glass transition temperature (Tg) that is sufficiently high to yield the desired corrosion resistance properties. The use of a polyester with a sufficiently high Tg can also be beneficial for avoiding coating blocking issues which can occur, for example, when coatings are in prolonged contact with each other such as may occur during transport and/or storage of coated substrate. Accordingly, the polyester polymer preferably has a glass transition temperature (Tg) of at least about 20° C., at least 25° C., at least about 30° C., at least about 35° C., at least about 40° C., at least about 45° C., at least about 50° C., at least about 55° C., or at least about 60° C. While the maximum Tg of the polymer is not particularly restricted, typically it will be less than about 120° C., less than about 100° C., less than about 80° C., less than about 70° C., less than about 60° C., or less than about 30° C. Differential scanning calorimetry (“DSC”) is a useful method for determining Tg. An example of a useful DSC methodology is provided later herein.

The polyester polymer preferably includes one or more cyclic groups (e.g. at least one monocyclic group), and more preferably a plurality of cyclic groups. Cyclic groups located in the polyester backbone are preferred, although pendant cyclic group(s) may also be present. In some embodiments, the polyester polymer includes one or more alicyclic groups optionally in combination with one or more aromatic and/or unsaturated cyclic groups. In preferred embodiments, the polyester polymer includes one or more cyclic groups selected from polycyclic groups or mono-cyclic groups having five ring members or less. Such cyclic groups may optionally include one or more heteroatoms (e.g., oxygen or nitrogen). Any suitable monomers may be used to introduce such cyclic groups into the polyester polymer, with preferred monomers including dicarboxylic acids (or an anhydride or alkyl ester of a dicarboxylic acid), diols, and combinations thereof. Typically, at least some of the polycyclic groups and/or monocyclic groups having five rings members or less are present in structural unit(s) derived from a diol.

When present, the polycyclic groups may include any suitable number of rings (e.g., 2, 3, or 4 or more), with bicyclic and tricyclic groups being preferred. Suitable bicyclic groups may include any combination of saturated, unsaturated, and/or aromatic rings, which may be fused, bridged, or spiro with respect to each other. Similarly, the tricyclic groups may be any combination of saturated, unsaturated, and/or aromatic rings in any configuration relative to one another (e.g., fused, bridged, and/or spiro). Examples of suitable polycyclic groups include a norbornane group, a norbornene group, an isosorbide group, a naphthalene group, a tricyclodecane group, and substituted variants thereof. In some embodiments, the polyester polymer includes one or more bicyclic-group-containing structural units derived from isosorbide; nadic acid; a Diels-Alder reaction product of maleic anhydride and dicyclopentadiene; a naphthalene dicarboxylic acid (e.g., 1,4- or 2,6-napthalene dicarboxylic acid); a spirocyclic diol (e.g., 3,9-bis(1,1-dimethyl-2-hydroxyethyl)-2,4,8,10-tetraoxaspiro[5.5]undecane (shown below)), a derivative thereof (e.g., nadic anhydride, methyl nadic acid, or methyl nadic anhydride), or a combination thereof.

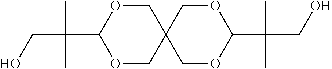 [SMILES: CC(C)(CO)C1OCC2(CO1)COC(C(C)(C)CO)OC2]

### 3,9-bis(1,1-dimethyl-2-hydroxyethyl)-2,4,8,10-tetraoxaspiro[5.5]undecane

In some embodiments, the polyester polymer includes one or more, more preferably a plurality, of tricyclic groups present in structural units derived from tricyclodecanedimethanol or a structural variant thereof (e.g., a substituted variant thereof).

As discussed above, in some embodiments, the polyester polymer may include one or more monocyclic groups having five ring members or less, with monocyclic groups having four or five members in the ring being preferred. In some embodiments, such monocyclic groups are alicyclic groups. Substituted or unsubstituted cyclobutane groups are preferred such monocyclic groups. Examples of suitable monomers for incorporating monocyclic groups having four ring members include cyclobutane diols, with 2,2,4,4-tetramethyl-1,3-cyclobutanediol shown below being on such example.

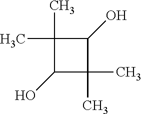

### 2,2,4,4-tetramethyl-1,3-cyclobutanediol

In some embodiments, the one or more monocyclic groups having 5-ring members or less may include one or more heteroatoms (e.g., nitrogen or oxygen) and/or one or more carbon-carbon double bonds, with furan groups being an example of such groups.

In some embodiments, the polyester polymer includes both (a) one or more aromatic cyclic groups (e.g., such as those present in backbone structural units formed from phthalic acid, terephthalic acid, isophthalic acid, or anhydrides or alkyl esters thereof), more typically a plurality of aromatic groups and (b) one or more, more typically a plurality of, polycyclic groups and/or monocyclic groups having 5 ring members or less. Typically, at least some (or all) of (a) are provided using a dicarboxylic acid (or anhydride or alkyl ester thereof) and at least some of (b) are provided using a diol.

In preferred embodiments, the polyester polymer is formed from reactants including: (i) one or more polycarboxylic acid (preferably a dicarboxylic acid), anhydride, or alkyl ester thereof and (ii) one or more polyol (preferably a diol). Aromatic dicarboxylic acids, anhydrides, or alkyl esters thereof are preferred polyacids. Diols having primary hydroxyl groups (as opposed to secondary or tertiary hydroxyl groups) are preferred diols. In preferred embodiments, a mixture of polyols is used that includes one or more cyclic-group-containing polyols (e.g., polyols including any of the cyclic groups recited herein). Preferably, at least 25 wt-%, at least 50 wt-%, at least 60 wt-%, at least 70 wt-%, at least 80 wt-%, at least 90 wt-%, or up to about 100 wt-% of the total polycarboxlic acid reactants used to make the polyester polymer are aromatic polycarboxylic acids, anhydrides, and/or alkyl esters. In preferred embodiments, the one or more polyols include a C4 or higher aliphatic diol including a linear carbon chain that is at least four carbons in length (e.g., 1,4-butanediol, 1,5-pentanediol, 1,6-hexanediol, or a mixture thereof), a cyclic-group containing diol (more preferably a polycyclic-group-containing diol and/or or a diol containing a cyclic group having 5 rings members or less), or a combination thereof.

In some embodiments, the one or more polyols used to form the polyester polymer includes both a cyclic-group-containing diol and a C4 or higher aliphatic diol having a linear chain that is at least four carbons in length, and even more preferably a C5 or higher aliphatic diol having a linear chain that is at least five carbons in length, and even more preferably 1,6-hexanediol. A polyol component including both cyclohexane dimethanol and 1,4-butanediol, 1,5-pentanediol, and/or 1,6-hexanediol is particularly preferred.

In some embodiments, the reactants used to form the polyester polymer include a C5 or higher aliphatic diol. The C5 or higher aliphatic diol preferably includes a carbon chain that is at least four carbons in length, more preferably at least five carbon atoms in length, with an alcohol group attached at each end of the carbon chain. 1,6-hexanediol is a preferred such C5 or higher aliphatic diol. In such embodiments, the polyester polymer preferably includes at least 1 wt-%, preferably at least 5 wt-%, and more preferably at least 10 wt-% of the C5 or higher aliphatic diol, based on the total weight of polyol reactants used to form the polyester polymer. In such embodiments, the polyester polymer preferably includes 40 wt-% or less, preferably 25 wt-% or less, and even more preferably 15 wt-% or less of the C5 or higher aliphatic diol, based on the total weight of polyol reactants used to form the polyester polymer.

It is believed that it can be quite beneficial from a coating performance standpoint if the polyester polymer includes one or more primary hydroxyl groups, and more preferably a plurality of primary hydroxyl groups. While not intending to be bound by theory, it is believed that primary hydroxyl groups can provide better crosslinking when used in combination with blocked polyisocyanate crosslinkers (e.g., as indicated by a higher number of MEK double rubs), and thus enhanced coating properties, relative to non-primary hydroxyl groups such as, e.g., secondary hydroxyl groups. Thus, in preferred embodiments, at least 50 mole percent (mol-%), at least 60 mol-%, at least 70 mol-%, at least 80 mol-%, at least 95 mol-%, at least 99 mol-%, or up to 100 mol-% of the one or more polyols used to form the polyester polymer are polyols having primary hydroxyl groups, more preferably polyols that only include primary hydroxyl groups (i.e., no secondary or tertiary hydroxyl groups), even more preferably diols having two primary hydroxyl groups.

Preferably, at least 50%, at least 60%, at least 70%, at least 80%, at least 90%, or up to 100% of the hydroxyl groups present on the polyester polymer are primary hydroxyl groups. Direct quantitation of the proportion of hydroxyl groups present on a polyester polymer that are primary hydroxyl groups versus non-primary hydroxyl groups may prove difficult, although nuclear magnetic resonance (“NMR”) may be one suitable method. Typically, such determination may be made based on the starting reactants used to make the polyester polymer.

Examples of suitable polyols for use in making the polyester of the present disclosure include diols, polyols having three or more hydroxyl groups (e.g., triols, tetraols, etc.), and combinations thereof. Suitable polyols may include, for example, ethylene glycol, propylene glycol, 1,3-propanediol, 2-methyl-1,3-propanediol, glycerol, diethylene glycol, dipropylene glycol, triethylene glycol, trimethylolpropane, trimethylol ethane, tripropylene glycol, neopentyl glycol, pentaerythritol, 1,4-butanediol, 1,6-hexanediol, hexylene glycol, cyclohexanedimethanol, tricyclodecane dimethanol, a polyethylene or polypropylene glycol, isopropylidene bis(p-phenylene-oxypropanol-2), 2,2,4,4-tetramethyl-1,3-cyclobutanediol, isosorbide, 2,5-furandiol, 2,2-dimethylpropane-1,3-diol (“NPG”), and mixtures thereof. If desired, adducts of polyol compounds (e.g., triols, tetraols, etc.) and monofunctional compounds may be used. In certain preferred embodiments, the polyols used to make the polyester polymer of the present disclosure include at least one polyol having three or more hydroxyl groups, with trimethylolpropane (TMP) being an example of a preferred such polyol.

Examples of suitable polycarboxylic acids include dicarboxylic acids, polycarboxylic acids having higher acid functionality (e.g., tricarboxylic acids, tetracarboxylic acids, etc.), anhydrides thereof, precursors or derivatives thereof (e.g., an esterifiable derivative of a polycarboxylic acid, such as a dimethyl ester or anhydride), or mixtures thereof. Suitable polycarboxylic acids may include, for example, maleic acid, fumaric acid, itaconic acid, succinic acid, adipic acid, phthalic acid, tetrahydrophthalic acid, methyltetrahydrophthalic acid, hexahydrophthalic acid, methylhexahydrophthalic acid, endomethylenetetrahydrophthalic acid, azelaic acid, sebacic acid, terephthalic acid, isophthalic acid, trimellitic acid, naphthalene dicarboxylic acid, cyclohexane dicarboxylic acid, glutaric acid, dimer fatty acids (e.g., Radiacid 960 dimer fatty acid), nadic acid, furandicarboxylic acid, anhydrides or derivatives thereof (e.g., nadic anhydride, maleic anhydride, etc.), and mixtures thereof. If desired, adducts of polyacid compounds (e.g., triacids, tetraacids, etc.) and monofunctional compounds may be used. It should be understood that in synthesizing the polyester, the specified acids may be in the form of anhydrides, esters (e.g., alkyl ester), or like equivalent form. For sake of brevity, such compounds are referred to herein as “carboxylic acids” or “polycarboxylic acids” or “dicarboxcylic acids”.

The polyester polymer of the present disclosure is preferably not made using any isocyanate reactants (e.g., diisocyanates). As such, in preferred embodiments, the polyester polymer does not include any urethane linkages and is not a polyester-urethane polymer.

In some embodiments, the hydroxyl-functional polyester polymer of the present disclosure includes less than 4 wt-%, less than 3 wt-%, less than 1 wt-%, less than 0.5 wt-%, or less than 0.1 wt-%, if any, of 1,4-butanediol, based on the total weight of reactants used to form the polyester polymer.

In some embodiments, the polyester polymer is a branched polyester polymer obtained from reactants that include a branching compound, such as reactants having three of more reactive functional groups, preferably three or more reactive functional groups capable of participating in an esterification or transesterification reaction. For instance, the branching compound can three reactive functional groups, preferably three reactive functional groups capable of participating in an esterification or transesterification reaction. In approaches, the reactive functional groups are selected from hydroxyl groups, carboxylic groups, alkyl ester groups, anhydride groups, or a mixture thereof. The branching compound can include a polyol (e.g., a triol), a polyacid (e.g., a tricarboxylic acid), or a mixture thereof. More specifically, in some embodiments, the branching compound includes a polyol selected from one or more of glycerol, di-glycerol, trimethylolethane, trimethylolpropane, trimethylolbutane, di-trimethylolethane, di-trimethylolpropane, di-trimethylolbutane, pentarerythritol, or a mixture thereof, and preferably, the branching compound is trimethylolpropane. The branching compound may also be trimellitic acid, trimellitic anhydride, an alkyl ester thereof, or a mixture thereof.

In some embodiments, when the polyester polymer is a branched polyester polymer, the polyester polymer includes at least about 0.1%, at least about 0.5%, at least about 1%, at least about 1.5%, or at least about 2% by weight of the one or more branching compounds, based on the weight of the one or more branching compounds relative to the total weight of reactants used to make the polyester polymer. In other embodiments, the polyester polymer may also include less than about 10%, less than about 5%, less than about 3%, or less than about 2% by weight of the one or more branching compounds, based on the weight of the one or more branching compounds relative to the total weight of reactants used to make the polyester polymer.

In other embodiments, the polyester polymer is a linear polyester prepared from reactants that do not include any branching compounds.

Coating compositions of the present disclosure may include any suitable amount of one or more polyester polymers. Typically, the hydroxyl-functional polyester polymer of the present disclosure will constitute at least 50 wt-%, at least 75 wt-%, at least 90 wt-%, at least 95 wt-%, at least 99 wt-%, or 100 wt-% of the polyester polymer present in the coating composition. Preferably, the coating composition, based on total resin solids, includes at least 40 wt-%, at least 50 wt-%, at least 60 wt-%, at least 70 wt-%, at least 80 wt-%, or at least 90 wt-% of the hydroxyl-functional polyester polymer of the present disclosure. Based on total coating solids (as opposed to total resin solids), typically the coating composition will include at least 30 wt-%, at least 40 wt-%, at least 50 wt-%, or at least 60 wt-% of the hydroxyl-functional polyester polymer of the present disclosure. In one approach, the coating compositions herein, based on total resin solids, includes at least about 30, at least about 40, at least about 50, at least about 60, at least about 70, at least about 80, or at least about 90% by weight of the polyester polymer.

Any suitable reaction process may be used to make the hydroxyl-functional polyesters of the present disclosure. Suitable such processes include, for example, processes in which polymerization occurs in the presence of a solvent such as reflux polymerization processes as well as processes in which polymerization occurs in the absence of added solvent such as melt-blend polymerization processes. The polyester polymer may, for example, be formed by direct esterification, transesterification, or a combination thereof, in one or more steps.

In preferred embodiments, at least a portion of a distribution of the formed polyester polymer chains includes at least one primary hydroxyl group. For example, the formed polyester polymer, on average, includes at least one primary hydroxyl group, and preferably, a least a portion of a distribution of the polyester polymer chains includes at least two primary hydroxyl groups, preferably, the formed polyester polymer, on average, includes at least 1.8, at least 1.9, or at least two primary hydroxyl group, and in some embodiments, at least a portion of a distribution of the polyester polymer chains includes at least three primary hydroxyl groups.

In some embodiments, the formed polyester polymer includes, on average, more than 2, more than about 2.2, more than about 2.5, more than about 2.7, more than about 2.9, or more than about 3 hydroxyl groups.

In some embodiments, at least 50%, at least 60%, at least 70%, at least 80%, at least 90%, or up to 100% of the hydroxyl groups present on the formed polyester polymer are primary hydroxyl groups.

In preferred embodiments, the formed polyester polymer includes a polyester backbone that includes a terminal hydroxyl group on at least one terminal end of the backbone, and more preferably, the backbone is terminated on each end with a hydroxyl group, and most preferably, at least one, and preferably both, of the hydroxyl groups are primary hydroxyl groups. In other embodiments, the polyester polymers herein a majority of primary hydroxyl groups and, for instance, include at least about 50 mole percent (mol-%), at least about 60 mol-%, at least about 70 mol-%, at least about 80 mol-%, at least about 95 mol-%, at least about 99 mol-%, or up to about 100 mol-% of the one or more polyols used to form the polyester polymer are polyols having primary hydroxyl groups, more preferably polyols that only include primary hydroxyl groups (i.e., no secondary or tertiary hydroxyl groups), even more preferably diols. In some embodiments, the reactants used to make the polyester polymers herein include, if any, less than about 20%, less than about 10%, less than about 5%, or less than about 1% by weight of polyols having secondary or tertiary hydroxyl groups. In some embodiments, the polyester polymer also preferably includes, if any, less than about 5%, less than about 2%, less than about 1%, or less than about 0.1% by weight of tetramethyl cyclobutanediol and isosorbide, based on the total weight of reactants used to make the polyester polymer.

### Blocked Polyisocyanate Crosslinker:

In preferred embodiments, the food or beverage container coating compositions herein includes at least one blocked polyisocyanate crosslinking resin. In embodiments, the at least one blocked polyisocyanate crosslinker has, on average, at least two primary isocyanate groups per molecule; and/or the at least one blocked polyisocyanate crosslinker has, on average, more than 50 mole percent of the isocyanate groups present on the at least one blocked polyisocyanate crosslinker are primary isocyanate groups; and/or the blocked polyisocyanate crosslinker is a reaction product of ingredients including a diisocyanate having two primary isocyanate groups. On average, the polyisocyanate crosslinker preferably includes more than two isocyanate groups, and more preferably more than two blocked isocyanate groups. Preferably, the vast majority (e.g., greater than 95%, greater than 98%, greater than 99%, etc.) of the blocked polyisocyanate crosslinker molecules include three or more isocyanate groups, and more preferably three or more block isocyanate groups. Typically all, or substantially all (e.g., >95%, >99%, >99.9%, >99.99%) of the isocyanate groups present in the blocked polyisocyanate crosslinker (i.e., in the total population of such crosslinker molecules) are blocked isocyanate groups (as opposed to free, or unblocked, isocyanate groups).

In some embodiments, the compositions herein have an isocyanate equivalent weight, based on total solids and both blocked and/or unblocked isocyanate groups, of at least about 0.005 equivalent weight, at least about 0.006 equivalent weight, at least about 0.007 equivalent weight, at least about 0.008 equivalent weight, at least about 0.009 equivalent weight, at least about 0.010 equivalent weight, at least about 0.012 equivalent weight, at least about 0.014 equivalent weight, or at least about 0.016 equivalent weight. In other embodiments, the compositions herein have an isocyanate equivalent weight, based on total solids, of less than about 0.02 equivalent weight, less than about 0.018 equivalent weight, or less than about 0.016 equivalent weight.

Primary isocyanate groups are preferred. Accordingly, the blocked polyisocyanate crosslinker preferably includes, on average, two or more blocked primary isocyanate groups. Preferably, the vast majority (e.g., greater than 95%, greater than 98%, greater than 99%, etc.) of the blocked polyisocyanate crosslinker molecules include three or more blocked primary isocyanate groups. While not intending to be bound by theory, it is believed that the use of blocked primary isocyanate groups can enhance reactivity and ultimately coating performance.

The blocked polyisocyanate group is typically a reaction product of ingredients including a diisocyanate having two primary isocyanate groups. Aliphatic diisocyanates are preferred, with aliphatic diisocyanates having at least one, and preferably two, primary isocyanate groups being particularly preferred. Hexamethylene diisocyanate (HDI) is a particularly preferred diisocyanate. An example of a preferred such blocked polyisocyanate compound is the DESMODUR BL 3272 MPA product commercially available from Covestro, which, according to literature from Covestro, is a blocked aliphatic polyisocyanate based on HDI, and is blocked with ε-caprolactam such that it includes three blocked primary isocyanate groups. In certain preferred embodiments, HDI is the only diisocyanate used to make the at least one blocked isocyanate crosslinker. In one embodiment, it is believed that a suitable blocked polyisocyanate (e.g., DESMODUR BL 3272 MPA) has the structure of Formula 1:

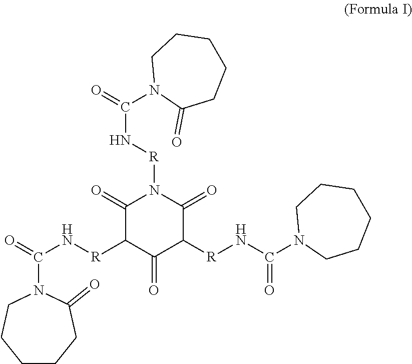

wherein R is an organic groups, such as a C1 to C20 hydrocarbyl group, and has a number average molecular weight (Mn) of less than about 2,000 g/mol, less than about 1,500 g/mol, less than about 1,200 g/mol, less than about 1,000 g/mol, or less than about 950 and, preferably, the blocked polyisocyanate crosslinker has a Mn of at least about 850 g/mol, and wherein at least about 95% of the isocyanate groups are blocked with a cyclic ester, preferably a lactone such as ε-caprolactam.

In presently preferred embodiments, the blocked polyisocyanate crosslinker is an isocyanate trimer. Such trimers are typically a trimerization reaction product prepared from on average three diisocyanate molecules. Materials and methods for making isocyanate trimers are well known in the art and, moreover, such trimers are readily commercially available. See, for example, U.S. Pat. Nos. 3,996,223, 6,936,678, and 8,293,937. In some embodiments, the blocked polyisocyanate crosslinker is a mixture comprising a high fraction of a blocked (ε-caprolactam blocked) hexamethylene diisocyanate isocyanurate trimer. While mono-trimers are typically the predominant species in such blocked polyisocyanate crosslinkers, lesser amounts of higher-level reactions products may be present such as oligomers formed from such trimers (e.g., polyisocyanate oligomers including two or more, three or more, etc. structural units formed from such trimers).

One or more blocking agents may be used to block the isocyanate groups of the blocked polyisocyanate crosslinker. A variety of factors will influence the selection of one or more blocking agents including, for example, the coating cure conditions (e.g., the temperature and duration of thermal cure of the coating composition) and toxicity concerns. ε-caprolactam is a particularly preferred blocking agent and preferably at least one, and more preferably a plurality, or all, of the blocked isocyanate groups present on the polyisocyanate are blocked with ε-caprolactam. In some embodiments, the blocked polyisocyanate crosslinker is prepared using ε-caprolactam as the only blocking agent. In some embodiments, the at least one blocked polyisocyanate crosslinker is prepared using a cyclic ester, preferably a lactone such as ε-caprolactam as the only blocking agent, and wherein at least about 95% of the isocyanate groups are blocked with a cyclic ester, preferably a lactone such as ε-caprolactam.

In one embodiment, ε-caprolactam blocked polyisocyanates derived from HDI (e.g., an HDI isocyanurate trimer) are examples of preferred blocked polyisocyanates. While not intending to be bound by theory, it is believed that such blocked polyisocyanates provide a superior balance of reactivity, coating substrate adhesion, and coating flexibility, as compared to other blocked polyisocyanate crosslinkers, while being safe for direct food-contact applications. Although not presently preferred, such blocked polyisocyanate crosslinkers may also be prepared from one or both of methyl ethyl ketoxime (MEKO) and isophorone diisocyanate (IPDI)—e.g., in combination with HDI and ε-caprolactam.

In one embodiment, the least one blocked polyisocyanate crosslinker is a reaction product of ingredients including one or more of hexamethylene diisocyanate (HDI), 1,4-diisocyanatobutane, pentamethylene diisocyanate (e.g., the DESMODUR N7300 product), 1,12-diisocyanatododecane, or one or more other diisocyanates selected from OCN—CH₂—R—CH₂—NCO with R being any branched or linear hydrocarbon chain (preferably aliphatic or cycloaliphatic), and preferably, selected from OCN—(CH₂)ₓ—NCO where x is an integer of from 1 to 20, more typically 2 to 12.

In other embodiments, the at least one blocked polyisocyanate is a reaction product of ingredients including a diisocyanate not having two primary isocyanate groups (e.g., isophorone diisocyanate (IPDI)). Thus, in some embodiments, the at least one blocked polyisocyanate is a reaction products of ingredients including both HDI, IPDI, and/or IPDI. In some embodiments, the at least one blocked polyisocyanate may be prepared from IPDI (e.g., via suitably reactions conditions) such that the primary isocyanate groups of IPDI are preferentially present on the trimer and available for participation in coating crosslinking reactions.

In some approaches or embodiments herein, the at least one blocked polyisocyanate crosslinker has a number average molecular weight (Mn) of less than about 2,000 g/mol, less than about 1,500 g/mol, less than about 1,200 g/mol, less than about 1,000 g/mol, or less than about 950 g/mol and, preferably, the blocked polyisocyanate crosslinker has an Mn of at least about 850 g/mol.

In other embodiments, the coating compositions herein, based on total solids weight, includes at least about 1%, at least about 5%, at least about 7.5%, at least about 10%, or at least about 15% by weight of the at least one blocked polyisocyanate crosslinker. In further approaches, the coating compositions herein, based on total solids weight, includes less than about 40%, less than about 30%, less than about 25%, less than about 20%, less than about 15%, less than about 10%, less than about 9%, or less than about 8% by weight of the at least one blocked polyisocyanate crosslinker.

### Other Crosslinking Resins

The coating composition may further include any of the well-known hydroxyl-reactive and/or acid-reactive curing (i.e., crosslinking) resins. Examples of suitable crosslinkers, in addition to the blocked polyisocyanate crosslinker, may include aminoplasts, phenoplasts, blocked isocyanates, beta-hydroxyalkyl amides, benzoxazines, carbonyl dicaprolactams, oxazolines, and combinations thereof.

Phenoplast resins include the condensation products of aldehydes with phenols. Formaldehyde and acetaldehyde are preferred aldehydes. Various phenols can be employed such as, for example, phenol, cresol, p-phenylphenol, p-tert-butylphenol, p-tert-amylphenol, and cyclopentylphenol, bisphenols, and polyphenols.

Aminoplast resins include, for example, the condensation products of aldehydes such as formaldehyde, acetaldehyde, crotonaldehyde, and benzaldehyde with amino- or amido-group-containing substances such as urea, melamine, and benzoguanamine. Examples of suitable aminoplast resins include benzoguanamine-formaldehyde resins, melamine-formaldehyde resins, esterified melamine-formaldehyde, urea-formaldehyde resins, and combinations thereof.

Condensation products of other amines and amides can also be employed such as, for example, aldehyde condensates of triazines, diazines, triazoles, guanadines, guanamines, and alkyl- and aryl-substituted melamines. Some examples of such compounds are N,N′-dimethyl urea, benzourea, dicyandimide, formaguanamine, acetoguanamine, glycoluril, ammelin 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. While the aldehyde employed is typically formaldehyde, other similar condensation products can be made from other aldehydes, such as acetaldehyde, crotonaldehyde, acrolein, benzaldehyde, furfural, glyoxal and the like, and mixtures thereof.

Other suitable crosslinkers include those described in U.S. Pat. Pub. No. 2016/0297994 (Kuo et al.) such as benzoxazine-based phenolic resins, U.S. Pat. Pub. No. 2016/0115347 (Kuo et al.) such as resole curable phenolic resins based on meta-substituted phenol, U.S. Pat. No. 9,598,602 (Kuo et al.) such as a phenolic resin substituted with at least one methylol group, U.S. Pub. No. 2016/0115345 (Kuo et al.) such as a resole phenolic resin containing the residues of an unsubstituted phenol and/or meta-substituted phenol), and U.S. Pat. Pub. No. 2017/0327272 (Chasser et al.) such as a polycarbodiimide. Other suitable crosslinkers include alkanolamide-type curing agents such as beta-hydroxyalkylamide crosslinkers available under the trade names PRIMID XL-552 and PRIMID QM-1260 from EMS-CHEMIE AG.

The level of any other crosslinker resins used will depend, for example, on the type of crosslinker, the time and temperature of the bake, and the molecular weight of the polymer. The crosslinker is typically present in an amount of at least 1 wt-%, at least 5 wt-%, at least 10 wt-%, or at least 15 wt-%, based on total resin solids present in the coating composition. In certain embodiments, the crosslinker is present in an amount of up to 40 wt-%, or up to 30 wt-%, or up to 25 wt-%, based on total resin solids present in the coating composition. These weight percentages are based upon the total weight of the resin solids in the coating composition.

If one or more crosslinkers other than the at least one blocked polyisocyanate crosslinker are included, such one or more other crosslinkers are preferably present in a lesser amount relative to the at least one blocked polyisocyanate crosslinker. Accordingly, in preferred embodiments, the at least one blocked polyisocyanate crosslinker constitutes at least a majority by weight (e.g., more than 50%, more than 60%, more than 70%, more than 80%, more than 90%, more than 95%, more than 99%, or all) of the total amount of crosslinker present in the coating composition.

In some embodiments, the coating composition is not made using any crosslinkers (and preferably any ingredients of any kind) derived from formaldehyde.

In some embodiments, the coating composition includes, by weight total solids, less than 10, less than 5, less than 3, less than 2, less than 1, or less than 0.1% by weight, if any, of novolak or epoxy novolak resin.

In some embodiments, the coating composition does not include any crosslinkers other than the at least one blocked isocyanate crosslinker.

### Coating Compositions:

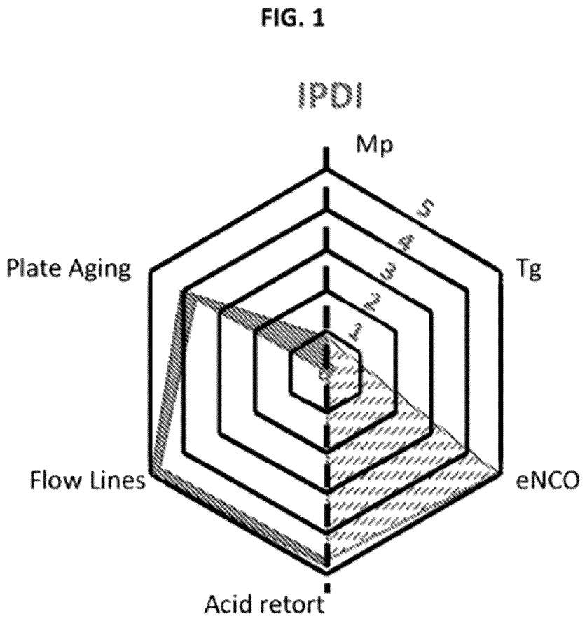

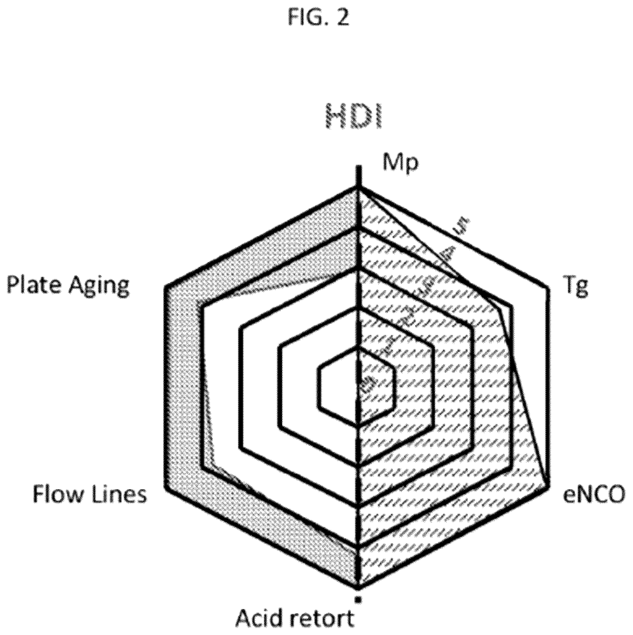

As shown in FIGS. 1 and 2, when coating compositions herein include the selected hydroxyl-functional polyester resins as described above combined with the selected blocked polyisocyanate crosslinker, then the compositions achieve desired performance in terms of flow lines, plate aging, and porosity after acid retort. On the radar charts of FIGS. 1 and 2, the compositional space on the right (in hatching) is opposed to the space of achievable coatings properties on the left (in light shading). Combining selected combinations of Mp (peak molecular weight), Tg (glass transition temperature), and eqNCO (equivalent isocyanate weight) of the hydroxyl-functional polyester resin within the right hatched space yields coatings properties located within the left shaded space. FIG. 1. shows that for composition comprising IPDI-based blocked polyisocyanate crosslinkers, the compositional space allowing a somewhat acceptable degree of performance is very narrow. Specifically, when IPDI-based polyisocyanate is used, the selection of hydroxyl-functional polyester polymers available in terms of peak molecular weight (Mp) is restricted to peak masses below 17,000 g/mol and to glass transition temperatures below 20° C., in order to achieve acceptable combination of plate aging, flow lines, and acid retort performance (for instance, ratings of 4 or above) on the left side of the chart. The equivalent weight of NCO functions in the coating composition is the only factor that may be more freely varied in order to maximize coatings properties of FIG. 1. On the other hand, FIG. 2 is the same radar chart built from of a variety of inventive compositions using HDI-based blocked polyisocyanate crosslinkers, showing the robust ability to use a wider variety of hydroxyl-functional polyester polymers in terms of peak molecular weight (e.g., higher Mp), and glass transition temperature (e.g., increased Tg) to achieve acceptable and/or enhanced plate aging, flow lines, and acid retort performance, while the freedom to use a full range of concentrations of isocyanate is maintained. In the radar charts of FIGS. 1 and 2, a rating of 0 is undesirable, a rating of 4 is desirable, and a rating of 5 is very desirable with the following being ratings for Mp, Tg, eqNCO, Acid retort, Flow Lines, and Plate Aging:

| | 0 - | 5 - |
|---|---|---|
| Radar Scale | undesirable | very desirable |
| Mp (g/mol) | 15,000 | 27,000 |
| Tg (° C.) | 20 | 60 |
| eqNCO | 0.016 | 0.007 |
| Acid retort (mA) | 5 | 1 |
| Average Flow Lines | 300 | 0 |
| (microns) | | |
| Plate Aging (mA) | 5 | 1 |

In some embodiments, the coating compositions of the present disclosure typically includes a liquid carrier, which is typically an organic-solvent-based liquid carrier. In preferred embodiments, the coating composition is a substantially non-aqueous liquid coating composition that includes no more than a de minimus amount of water, if any (i.e., less than 2 wt-% of water, less than 1 wt-% of water, or less than 0.1 wt-% of water, if any). Suitable organic solvents include ketones, glycol ethers, esters, alcohols, aromatics, and combinations thereof. Examples of such solvents include cyclohexanone, carbitol, butyl carbitol, butylcellosolve, butanol, methyl isobutyl ketone, methyl isoamyl ketone, methyl amyl ketone, xylene, aromatic 150, aromatic 100, hexylcellosolve, toluene, propylene glycol monomethyl ether acetate, propylene glycol monomethyl ether, dibasic ester, ethyl carbitol, diisobutyl ketone, and mixtures thereof.

The amount of liquid carrier included in a coating composition of the present disclosure is limited only by the desired, or necessary, rheological properties of the composition. Usually, a sufficient amount of liquid carrier is included in the coating composition to provide a composition that can be processed easily and that can be applied to a metal substrate easily and uniformly using a particular application process, and that is sufficiently removed from the coating composition during curing within the desired cure time. In some embodiments, a coating composition typically includes at least 30 wt-% of liquid carrier and more typically at least 40 wt-%, at least 50 wt-% of liquid carrier, or at least 60 wt-% of liquid carrier. Alternatively stated, in some embodiments, a coating composition will typically include no more than 70 wt-% of solids, no more than 60 wt-% of solids, no more than 50 wt-% of solids, or no more than 45 wt-% of solids. In some embodiments, a coating composition will typically include less than 70 wt-% of liquid carrier, less than 65 wt-% of liquid carrier, or less than 60 wt-% of liquid carrier. Alternatively stated, in some embodiments, a coating composition will typically include at least 30 wt-% of solids, more typically at least 40 wt-% of solids. These weight percentages are based upon the total weight of the coating composition.

In some embodiments, the coating composition of the present disclosure is an organic-solvent-based “gold” coating suitable for use, for example, on the interior of a three-piece food can on the sidewalls and/or can ends (including on the interior surface of a riveted easy open can end). In such embodiments, the coating composition preferably includes a phenoplast crosslinker, more preferably a resole phenolic crosslinker.

In certain embodiments, the container coating compositions (whether aqueous or solvent-based) may include a catalyst to increase the rate of cure and/or the extent of crosslinking of the polyester and make the overall coating a thermoset coating. Nonlimiting examples of catalysts, include, but are not limited to, strong acids (e.g., dodecylbenzene sulphonic acid (DDBSA, available as CYCAT 600 from Cytec), methane sulfonic acid (MSA), p-toluene sulfonic acid (pTSA), dinonylnaphthalene disulfonic acid (DNNDSA), and triflic acid), quaternary ammonium compounds, phosphorous compounds, tin compounds, titanium compounds, zirconium compounds, zinc compounds, and combinations thereof. Examples include a tetraalkyl ammonium halide, a tetraalkyl or tetraaryl phosphonium iodide or acetate, tin octoate, zinc octoate, triphenylphosphine, and similar catalysts known to persons skilled in the art. If used, a catalyst is preferably present in an amount of at least 0.01 wt-%, and more preferably at least 0.1 wt-%, based on the weight of nonvolatile material in the coating composition. If used, a catalyst is preferably present in an amount of no greater than 3 wt-%, and more preferably no greater than 1 wt-%, based on the weight of nonvolatile material in the coating composition.

The coating composition of the present disclosure may also include other optional ingredients that do not adversely affect the coating composition or a cured coating resulting therefrom. Such optional ingredients are typically included in a coating composition to enhance composition esthetics, to facilitate manufacturing, processing, handling, and application of the composition, and to further improve a particular functional property of a coating composition or a cured coating resulting therefrom.

Such optional ingredients include, for example, dyes, pigments, toners, extenders, fillers, lubricants, defoamers, anticorrosion agents, flow control agents, thixotropic agents, dispersing agents, antioxidants, adhesion promoters, light stabilizers, and mixtures thereof. Each optional ingredient is included in a sufficient amount to serve its intended purpose, but not in such an amount to adversely affect a coating composition or a cured coating resulting therefrom. The amounts of such additives can be determined readily by one of skill in the art.

A particularly useful optional ingredient is a lubricant, which facilitates manufacture of coated articles (e.g., food or beverage can ends) by imparting lubricity to planar coated metal substrate. A lubricant may be present in the coating composition in an amount of at least 0.1 wt-%, or at least 0.3 wt-%, based on nonvolatile material. A lubricant may be present in the coating composition in an amount of up to 5 wt-%, or up to 3.5 wt-%, based on nonvolatile material. Exemplary lubricants include, for example, Carnauba wax, polyethylene- and polypropylene-type lubricants, polytetrofluoroethylene (PTFE)-modified polyethylene lubricants, and Fisher-Tropsch lubricants.

Another particularly useful optional ingredient is a pigment such as, for example, inorganic pigments like titanium dioxide. Titanium dioxide is a preferred pigment for us in formulating white food or beverage container coating composition embodiments of the present disclosure. For pigmented embodiments such as, for example, interior white hard-to-hold food or beverage container coating compositions, pigment (e.g., an inorganic pigment such as titanium dioxide) is typically present in the coating composition in an amount of at least about 1 wt-%, at least about 5 wt-%, at least about 10 wt-%, at least about 20 wt-%, at least about 25 wt-%, at least about 30 wt-%, or at least about 40 wt-% based on the total solids of the coating composition. For pigmented embodiments such as, for example, interior white hard-to-hold food or beverage container coating compositions, pigment (e.g., an inorganic pigment such as titanium dioxide) is typically present in the coating composition in an amount of no greater than about 70 wt-%, no greater than about 60 wt-%, no greater than about 50 wt-%, or no greater than 45 wt-%, or no greater than 35 wt-% based on the total solids weight of the coating composition. While the pigment is preferably titanium dioxide, the compositions herein may also include as pigments barium sulfate, calcium sulfate, zinc sulfide, aluminum power, iron oxide, or combinations thereof.

In some embodiments, the coating composition of the present disclosure is an organic-solvent-based “white” coating composition for as an interior coating composition on the sidewalls and/or ends of a three-piece food can.

The coating compositions of the present disclosure can exhibit any suitable viscosity. Preferably, the coating composition has a viscosity of up to 150 seconds, up to 125 seconds, up to 100 seconds, or up to 95 seconds, or up to 85 seconds (ISO Cup number 6 at 25° C.). While not intending to be bound by theory, it may be advantageous in the case of gold 3-piece food or beverage container coating compositions to use a lower relative viscosity (e.g., about 50-75 seconds, more preferably about 55-65 seconds per ISO Cup number 6 at 25° C.) than for a white 3-piece food or beverage container coating compositions (e.g., about 95-100 seconds per ISO Cup number 6 at 25° C.).

The coating composition can exhibit any suitable amount of total coating solids. In preferred embodiments, the coating composition includes at least about 25 wt-%, at least about 30 wt-%, at least about 35 wt-%, or at least about 40 wt-% of total coating solids. Typically, the coating compositions will include up to about 70 wt-%, up to about 60 wt-%, or up to about 55 wt-% of total coating solids.

The coating compositions of the present disclosure are preferably storage stable under normal storage conditions (15° C. to 30° C.) for at least 1 month, at least 3 months, at least 6 months, or at least 1 year. In this context, storage stable means that the compositions do not separate into layers or demonstrate significant viscosity variation, there is no crystallization, and/or there is no performance deviation of the resultant cured film.

As used herein, a bisphenol compound refers to a polyhydric polyphenol having two phenylene groups (i.e., a six-carbon atom aryl ring having any substituent groups including hydrogen atoms, halogens, hydroxyl groups, etc.) that each include six-carbon rings and a hydroxy (—OH) group attached to a carbon atom of the ring, wherein the rings of the two phenylene groups do not share any atoms in common. As used herein, “structural units derived therefrom” includes diepoxide groups of bisphenols, such as in BADGE (Bisphenol A diglycidyl ether).

In certain embodiments, the container coating compositions of the present disclosure are substantially free of each of bisphenol A, bisphenol F, and bisphenol S, as well as structural units derived therefrom. Although bisphenol compounds may be used, in some embodiments, the container coating compositions are substantially free of structural units derived from all bisphenol compounds, as well as structural units derived therefrom. As used herein, the term “substantially free” means that the container coating compositions of the present disclosure contain less than 1000 parts per million (ppm), if any, of each of bisphenol A, bisphenol F, and bisphenol S, as well as structural units derived therefrom (in total), or in some embodiments all bisphenol compounds, as well as structural units derived therefrom (in total).

In certain embodiments, the container coating compositions are essentially free of each of bisphenol A, bisphenol F, and bisphenol S, as well as structural units derived therefrom. As used herein, the term “essentially free” means that the container coating compositions of the present disclosure contain than 100 ppm, if any, of each of bisphenol A, bisphenol F, and bisphenol S, as well as structural units derived therefrom (in total), or in some embodiments all bisphenol compounds, as well as structural units derived therefrom (in total).

In certain embodiments, the container coating compositions are essentially completely free of each of bisphenol A, bisphenol F, and bisphenol S, as well as structural units derived therefrom. As used herein, the term “essentially completely free” means that the container coating compositions of the present disclosure contain less than 5 ppm, if any, of each of bisphenol A, bisphenol F, and bisphenol S, as well as structural units derived therefrom (in total).

In certain embodiments, the container coating compositions are completely free of each of bisphenol A, bisphenol F, and bisphenol S, as well as structural units derived therefrom. As used herein, the term “completely free” means that the container coating compositions of the present disclosure contain less than 20 parts per billion (ppb), if any, of each of bisphenol A, bisphenol F, and bisphenol S, as well as structural units derived therefrom (in total).

Coating compositions of the present disclosure may be prepared by conventional methods in various ways. For example, the coating compositions may be prepared by simply admixing the polyester, crosslinker and any other optional ingredients, in any desired order, with sufficient agitation. The resulting mixture may be admixed until all the composition ingredients are substantially homogeneously blended. Alternatively, the coating compositions may be prepared as a liquid solution or dispersion by admixing an optional carrier liquid, polyester, crosslinker, and any other optional ingredients, in any desired order, with sufficient agitation. An additional amount of carrier liquid may be added to the coating compositions to adjust the amount of nonvolatile material in the coating composition to a desired level.

Use of coating compositions of the present disclosure include: providing a coating composition as described herein; applying the coating composition to at least a portion of a metal substrate prior to or after forming the metal substrate into a food or beverage container (e.g., a can) or portion thereof, and thermally curing the coating composition.

In certain embodiments of such methods, the metal substrate includes a steel or aluminum substrate. In certain embodiments of such methods, the coating composition is applied to a preformed food or beverage container or a portion thereof. That is, in certain embodiments, the metal substrate is in the form of a preformed food or beverage can having a sidewall and a bottom end, and spraying comprises spraying an interior surface of the sidewall and bottom end.

In certain embodiments of such methods, the coating composition is applied to a food-contact surface of the metal substrate (e.g., an interior side of a food can or a surface that will become an interior side of a food can). Thus, methods of the present disclosure can involve applying the coating composition to a flat substrate, and then forming the flat metal substrate into at least a portion of a container (e.g., food or beverage can) after thermally curing the coating composition.

The coating compositions of the present disclosure also have utility as exterior food or beverage container coatings. For example, in some embodiments, the coating composition of the present disclosure is present on both an interior surface and an exterior surface of a food can (e.g., a 3-piece food can).

The disclosed coating compositions may be present as a layer of a mono-layer coating system or as one or more layers of a multi-layer coating system. The coating compositions can be used as a primer coat, an intermediate coat, a top coat, or a combination thereof. The coating thickness of a particular layer and of the overall coating system will vary depending upon the coating material used, the substrate, the coating application method, and the end use for the coated article. In certain embodiments, a coating prepared from a coating composition of the present disclosure, particularly if an inside container coating, has an average overall coating thickness of at least 1 micron, more typically at least 5 microns, and even more typically at least 10 microns and often up to 20 or even 30 microns.

Mono-layer or multi-layer coating systems including one or more layers formed from the disclosed coating compositions may have any suitable overall coating thickness, and typically are applied, using the mixed units commonly employed in the packaging industry, at coating weights of 1 milligram per square inch (mg/in² or msi) (i.e., 1.55 gram per square meter (g/m²)) to 20 mg/in² (i.e., 31 g/m²), and more typically at 1.5 mg/in² to 10 mg/in² (i.e., 2.3 g/m² to 15.5 g/m²). That is, in certain embodiments, the cured coating has an average dry film weight of 1 mg/in² (i.e., 1.55 g/m²) to 20 mg/in² (i.e., 31 g/m²). Typically, the cured coating weight for rigid metal containers (e.g., food or beverage cans) are 1 mg/in² (i.e., 1.55 g/m²) to 6 mg/in² (i.e., 9.3 g/m²). In certain embodiments in which a coating composition of the present disclosure is used as an interior coating on a drum (e.g., a drum for use with food or beverage products), the coating weight may be approximately 20 mg/in² (i.e., 31 g/m²).

In certain preferred embodiments, the coating compositions of the present disclosure exhibit excellent cure properties as evidenced, for example, by a high number of MEK double rubs. Preferred coating compositions of the present disclosure, when applied on tin-plate steel can stock substrate and baked for 15 minutes in a 200° C. oven to achieve a cured coating having an average dry film weight of about 15 grams per square meter, exhibit an MEK double rub value in the MEK test described herein of at least about 25, more preferably at about 35, even more preferably at least about 40, even more preferably at least about 60, even more preferably at least about 80, or optimally at least about 100. Preferably, the coating compositions exhibit such MEK double rub resistance values when using a 1,000 gram weight in the test, and more preferably the coating compositions also exhibits such MEK double rub resistance values when using a 2,000 gram weight. While not intending to be bound by theory, it is believed that the high number of MEK double rubs is attributable to the use of the blocked polyisocyanate crosslinker of the present disclosure in combination with the hydroxyl-functional polyester polymers disclosed herein.

In certain embodiments, cured coatings formed from the coating compositions described herein have a high degree of flexibility, which can be a very useful property in food and beverage cans, for example. Flexibility can be evaluated by the Porosity Test described in the Examples Section, wherein a coating is applied, e.g., on Electrolytic Tin plate (18/100, 2.8/2.8, TH550) at a dry film weight of 15±1 g/m² and cured for 15 minutes at 200-205° C. (PMT). A coating is considered to satisfy the Porosity Test if it passes an electric current (after end formation) of less than about 10 milliamps (mA) (more preferably less than 5 mA, even more preferably less than 2 mA or less than 1 mA) when tested according to the Porosity Test.

The metal substrate used in forming rigid containers (e.g., food or beverage cans), or portions thereof, typically has a thickness in the range of 125 microns to 635 microns. Electro tinplated steel, cold-rolled steel, and aluminum are commonly used as metal substrates for food or beverage cans, or portions thereof. In embodiments in which a metal foil substrate is employed in forming, e.g., a packaging article, the thickness of the metal foil substrate may be even thinner that that described above.

The disclosed coating compositions may be applied to a substrate either prior to, or after, the substrate is formed into an article such as, for example, a food or beverage container or a portion thereof. In one embodiment, a method of forming food or beverage containers is provided that includes: applying (e.g., via spray application, dipping, curtain coating, washing coating, roll coating, etc.) a coating composition described herein to a metal substrate (e.g., applying the composition to the metal substrate in the form of a planar coil or sheet), thermally curing the coating composition, and forming (e.g., via stamping) the substrate into a packaging container or a portion thereof (e.g., a food or beverage can or a portion thereof). For example, two-piece or three-piece food cans or portions thereof such as can ends (including, e.g., rivetted easy open food can ends) with a cured coating of the disclosed coating composition on a surface thereof can be formed in such a method.

The disclosed coating compositions are particularly well adapted for use on food cans (e.g., two-piece cans, three-piece cans, etc.). Two-piece cans are manufactured by joining a can body (typically a drawn metal body) with a can end (typically a drawn metal end). The disclosed coatings are suitable for use in food or beverage contact situations and may be used on the inside and/or outside of such cans (e.g., as a continuous inside coating, for example, on the interior can side of a sheet formed into food can end or food can body). They are particularly suitable for use on so-called three-piece food cans and exhibit excellent powder adhesion with the side seam powder compositions frequently used to coat the weld on the sidewall of three-piece food cans, which avoids any corrosion problems at the junction between the coatings of the present disclosure and the cured side seam stripe formed from the side seam powder. Preferred coating compositions of the present disclosure exhibit such excellent powder adhesion, while still exhibiting an excellent balance of other coating properties (e.g., excellent cure, substrate adhesion, corrosion resistance, flexibility, scratch resistance, block resistance, aesthetic properties, and the like). The disclosed coating compositions also offer utility in other applications.

For any of the application techniques described above, the curing process may be performed in either discrete or combined steps. For example, substrates can be dried at ambient temperature to leave the coating composition in a largely uncrosslinked state. The coated substrates can then be heated to fully cure the compositions. In certain instances, the disclosed coating compositions may be dried and cured in one step. The cure conditions will vary depending upon the method of application and the intended end use.

In certain embodiments, coating composition of the present disclosure is thermally curable. In this context, thermally curable refers to conditions of temperature and time usually used in container coating lines. The thermal curing process may be performed at any suitable temperature, including, for example, oven temperatures in the range of from 170° C. to 230° C., and more typically from 190° C. to 220° C., for a time period of 10 seconds to 30 minutes, more typically for a time period of 30 seconds to 20 minutes, and in some embodiments 10 to 20 minutes. If the substrate to be coated is a metal coil, curing of the applied coating composition may be conducted, for example, by heating the coated metal substrate over a suitable time period to a peak metal temperature (“PMT”) of preferably greater than 180° C. More preferably, the coated metal coil is heated for a suitable time period (e.g., 5 to 900 seconds) to a PMT of at least about 200° C. Other commercial coating application and curing methods are also envisioned, for example, electrocoating, extrusion coating, laminating, powder coating, and the like.

In other embodiments, the present disclosure also provides methods that include “causing” any embodiment of the concentrate or the aqueous coating ocmposition herein to be used on a metal substrate (or portion thereof) of a metal food or beverage container or packaging and, more specifically, a beverage end coil substrate. In some cases, where multiple parties are involved, a first party (e.g., the party that manufactures and/or supplies the coating composition) may provide instructions, recommendations, or other disclosures about the food or beverage container coating composition end use to a second party (e.g., a metal coater (e.g., a coil coater for beverage can ends), can maker, or brand owner). Such disclosures may include, for example, instructions, recommendations, or other disclosures relating to coating a metal substrate for subsequent use in forming packaging containers or portions thereof, coating a metal substrate of pre-formed containers or portions thereof, preparing powder coating compositions for such uses, cure conditions or process-related conditions for such coatings, or suitable types of packaged products for use with resulting coatings. Such disclosures may occur, for example, in technical data sheets (TDSs), safety data sheets (SDSs), regulatory disclosures, warranties or warranty limitation statements, marketing literature or presentations, or on company websites. A first party making such disclosures to a second party shall be deemed to have “caused” any embodiment of the coating compositions herein to be used on a metal substrate of metal packaging (e.g., a container or closure) even if it is the second party that actually applies the composition to a metal substrate in commerce, uses such coated substrate in commerce on a metal substrate of packaging containers, and/or fills such coated containers with product.

### EXEMPLARY EMBODIMENTS

Embodiment 1 is a food or beverage container coating composition suitable for coating, at least a portion of, a food or beverage container and, preferably an inner side of a food or beverage container, the food or beverage container coating composition comprising: a hydroxyl-functional polyester polymer wherein the hydroxyl-functional polyester polymer optionally has a glass transition temperature (Tg) of about 20° C. or higher, as determined by differential scanning calorimetry (DSC); and at least one blocked polyisocyanate crosslinker, wherein: (i) the at least one blocked polyisocyanate crosslinker has, on average, at least two primary isocyanate groups per molecule; and/or (ii) the at least one blocked polyisocyanate crosslinker has, on average, more than 50 mole percent of the isocyanate groups present on the at least one blocked polyisocyanate crosslinker are primary isocyanate groups; and/or (iii) the blocked polyisocyanate crosslinker is a reaction product of ingredients including a diisocyanate having two primary isocyanate groups.
Embodiment 2 is the food or beverage container coating composition of Embodiment 1, wherein the hydroxyl-functional polyester polymer has, on average, at least 1.8, at least 1.9, or at least about 2 hydroxyl groups per molecule.
Embodiment 3 is the food or beverage container coating composition of Embodiment 1 wherein the hydroxyl-functional polyester polymer has a glass transition temperature (Tg) of about 20° C. or higher, as determined by differential scanning calorimetry (DSC)
Embodiment 4 is the food or beverage container coating composition of embodiment 1, 2, or 3, wherein (i) and (ii) are true.
Embodiment 5 is the food or beverage container coating composition of embodiment 1, 2, or 3, wherein (i) and (iii) are true.
Embodiment 6 is the food or beverage container coating composition of embodiment 1, 2, or 3, wherein (ii) and (iii) are true.
Embodiment 7 is the food or beverage container coating composition of embodiment 1, 2, or 3, wherein (i), (ii), and (iii) are all true, which is most preferred.
Embodiment 8 is the food or beverage container coating composition of any preceding embodiment, wherein the hydroxyl-functional polyester polymer does not include polycyclic cycloaliphatic groups.
Embodiment 9 is the food or beverage container coating composition of any preceding embodiment, wherein the composition has an isocyanate equivalent weight (blocked and unblocked), based on total solids, of at least about 0.005 equivalent weight, at least about 0.006 equivalent weight, at least about 0.007 equivalent weight, at least about 0.008 equivalent weight, at least about 0.009 equivalent weight, at least about 0.010 equivalent weight, at least about 0.012 equivalent weight, at least about 0.014 equivalent weight, or at least about 0.016 equivalent weight.
Embodiment 10 is the food or beverage container coating composition of any preceding embodiment, wherein the composition has an isocyanate equivalent weight, based on total solids, of less than about 0.02 equivalent weight, less than about 0.018 equivalent weight, or less than about 0.016 equivalent weight.
Embodiment 11 is the food or beverage container coating composition of any preceding embodiment, wherein the coating composition is an interior food or beverage container coating composition.
Embodiment 12 is the food or beverage container coating composition of any preceding embodiment, wherein the at least one blocked polyisocyanate crosslinker includes, on average, three or more isocyanate groups, preferably three or more blocked isocyanate groups.
Embodiment 13 is the food or beverage container coating composition of any preceding embodiment, wherein the at least one blocked polyisocyanate crosslinker includes, on average, three or more primary isocyanate groups, preferably three or more blocked primary isocyanate groups.
Embodiment 14 is the food or beverage container coating composition of any preceding embodiment, further comprising at least 1 weight percent of an inorganic pigment (e.g., titanium dioxide), based on total solids in the coating composition.
Embodiment 15 is the food or beverage container coating composition of any preceding embodiment, wherein the at least one blocked polyisocyanate crosslinker is a reaction product of ingredients including an aliphatic diisocyanate.
Embodiment 16 is the food or beverage container coating composition of embodiment 15, wherein aliphatic diisocyanate has two primary isocyanate groups (i.e., two free primary isocyanate groups).
Embodiment 17 is the food or beverage container coating composition of any preceding embodiment, wherein the at least one blocked polyisocyanate crosslinker is a reaction product of ingredients including one or more of hexamethylene diisocyanate (HDI), 1,4-diisocyanatobutane, pentamethylene diisocyanate (e.g., the DESMODUR N7300 product), 1,12-diisocyanatododecaneor, or one or more other diisocyanates selected from OCN—CH₂—R—CH₂—NCO with R being any branched or unbranched hydrocarbon chain, and preferably, selected from OCN—(CH₂)ₓ—NCO where x is an integer of from 1 to 20, more typically 2 to 12.
Embodiment 18 is the food or beverage container coating composition of any preceding embodiment, wherein the at least one blocked polyisocyanate crosslinker is a reaction product of ingredients including one or more of hexamethylene diisocyanate (HDI),
Embodiment 19 is the food or beverage container coating composition of any preceding embodiment, wherein the at least one blocked polyisocyanate is a reaction product of ingredients including a diisocyanate not having two primary isocyanate groups (e.g., isophorone diisocyanate (IPDI)). Thus, in some embodiments, the at least one blocked polyisocyanate is a reaction products of ingredients including both HDI and IPDI. In some embodiments, the at least one blocked polyisocyanate may be prepared from IPDI (e.g., via suitably reactions conditions) such that the primary isocyanate groups of IPDI are preferentially present on the trimer and available for participation in coating crosslinking reactions.
Embodiment 20 is the food or beverage container coating composition of any preceding embodiment, wherein the coating composition includes an additional blocked isocyanate crosslinker (i.e., in addition to the at least one blocked isocyanate crosslinker) that is a reaction product of a diisocyanate other than HDI (e.g., a diisocyanate having one or more secondary isocyanate groups).
Embodiment 21 is the food or beverage container coating composition of embodiment 20, wherein the diisocyanate other than HDI is isophorone diisocyanate (IPDI).
Embodiment 22 is the food or beverage container coating composition of embodiment 16 or 18, wherein HDI is the only diisocyanate used to make the at least one blocked isocyanate crosslinker.
Embodiment 23 is the food or beverage container coating composition of any preceding embodiment, wherein the at least one blocked polyisocyanate crosslinker comprises an isocyanate trimer.
Embodiment 24 is the food or beverage container coating composition of any preceding embodiment, wherein the at least one blocked polyisocyanate crosslinker is a trimerization product prepared from, on average, three diisocyanate molecules.
Embodiment 25 is the food or beverage container coating composition of any preceding embodiment, wherein the at least one blocked polyisocyanate crosslinker comprises a blocked hexamethylene diisocyanate isocyanurate trimer. The polyisocyanate crosslinker may optionally further comprise higher level reaction products (typically in lesser amounts relative to the trimer) such as oligomers formed from such trimers (e.g., polyisocyanate oligomers including two or more, three or more, etc. structural units formed from such trimers.)
Embodiment 26 is the food or beverage container coating composition of any preceding embodiment, wherein at least one isocyanate group is blocked with a cyclic ester, preferably a lactone such as ε-caprolactam.
Embodiment 27 is the food or beverage container coating composition of any preceding embodiment, wherein at least two isocyanate groups are blocked with a cyclic ester, preferably a lactone such as ε-caprolactam.
Embodiment 28 is the food or beverage container coating composition of any preceding embodiment, wherein at least three isocyanate groups are blocked with a cyclic ester, preferably a lactone such as ε-caprolactam.
Embodiment 29 is the food or beverage container coating composition of any preceding embodiment, wherein the at least one blocked polyisocyanate crosslinker is prepared using a cyclic ester, preferably a lactone such as ε-caprolactam as the only blocking agent, and wherein at least about 95% of the isocyanate groups are blocked with a cyclic ester, preferably a lactone such as ε-caprolactam.
Embodiment 30 is the food or beverage container coating composition of any preceding embodiment, wherein the at least one blocked polyisocyanate crosslinker has a number average molecular weight (Mn) of less than about 2,000 g/mol, less than about 1,500 g/mol, less than about 1,200 g/mol, less than about 1,000 g/mol, or less than about 950 and, preferably, the blocked polyisocyanate crosslinker has an Mn of at least about 850 g/mol.
Embodiment 31 is the food or beverage container coating composition of any preceding embodiment, wherein the coating composition, based on total solids weight, includes at least about 1%, at least about 5%, at least about 7.5%, at least about 10%, or at least about 15% by weight of the at least one blocked polyisocyanate crosslinker.
Embodiment 32 is the food or beverage container coating composition of any preceding embodiment, wherein the coating composition, based on total solids weight, includes less than about 40%, less than about 30%, less than about 25%, less than about 20%, less than about 15%, less than about 10%, less than about 9%, or less than about 8% by weight of the at least one blocked polyisocyanate crosslinker.
Embodiment 33 is the food or beverage container coating composition of any preceding embodiment, wherein the coating composition includes, based on total solids weight, from at least about 7.5% to less than about 20% of the at least one blocked polyisocyanate crosslinker.
Embodiment 34 is the food or beverage container coating composition of any preceding embodiment, wherein the polyester polymer has a peak molecular weight (Mp), as determined by gel permeation chromatography (GPC) using polystyrene standards, of less than about 30,000, less than about 29,000, less than about 28,000, less than about 27,000, less than about 26,000 less than about 25,000, less than about 24,000, less than about 23,000, less than about 22,000, less than about 21,000, or less than 20,000.
Embodiment 35 is the food or beverage container coating composition of any preceding embodiment, wherein the polyester polymer has a peak molecular weight (Mp), as determined by gel permeation chromatography (GPC) using polystyrene standards, of at least at least about 15,000, at least about 16,000, at least about 17,000, at least about 18,000, at least about 19,000, at least about 20,000, at least about 21,000, at least about 22,000, or at least 23,000.
Embodiment 36 is the food or beverage container coating composition of any preceding embodiment, wherein the polyester polymer has a polydispersity index (PDI or Mw/Mn), as determined by GPC using polystyrene standards, of at least about 2.0, at least about 2.1, at least about 2.2, or at least about 2.25.
Embodiment 37 is the food or beverage container coating composition of any preceding embodiment, wherein the polyester polymer has a polydispersity index (PDI), as determined by GPC using polystyrene standards, of no more than about 10, no more than about 8, no more than about 5, or no more than about 3.
Embodiment 38 is the food or beverage container coating composition of any preceding embodiment, wherein the polyester polymer has a hydroxyl value of at least about 5, at least about 10, at least about 15, or at least about 20 mg KOH/g resin.
Embodiment 39 is the food or beverage container coating composition of any preceding embodiment, wherein the polyester polymer has a hydroxyl value of less than about 100, less than about 80, less than about 60, less than about 50, less than about 40, less than about 30, less than about 25, less than about 20, less than about 15, or less than about 10 mg KOH/g resin.
Embodiment 40 is the food or beverage container coating composition of any preceding embodiment, wherein the polyester polymer has a hydroxyl value of more than about 5 to less than about 50 mg KOH/g resin, at least about 10 to no more than 30 mg KOH/g resin, or at least about 15 to no more than about 35 mg KOH/g resin.
Embodiment 41 is the food or beverage container coating composition of any preceding embodiment, wherein the polyester polymer has an acid value, if any, of less than 20, less than 10, less than 5, less than 3, less than 2, or less than 1 mg KOH/g resin.
Embodiment 42 is the food or beverage container coating composition of any preceding embodiment, wherein the polyester polymer has a glass transition temperature (Tg) of at least 25° C., at least about 30° C., at least about 35° C., at least about 40° C., at least about 45° C., at least about 50° C., at least about 55° C., or at least about 60° C. as determined by differential scanning calorimetry (DSC).
Embodiment 43 is the food or beverage container coating composition of any preceding embodiment wherein, the polyester polymer has a glass transition temperature (Tg) of less than about 120° C., less than about 100° C., less than about 80° C., less than about 70° C., less than about 60° C., or less than about 30° C., as determined by differential scanning calorimetry (DSC).
Embodiment 44 is the food or beverage container coating composition of any preceding embodiment, wherein the polyester polymer has a glass transition temperature of from at least about 30° C. (or at least about 40° C. or at least about 50° C.) to less than about 100° C.
Embodiment 45 is the food or beverage container coating composition of any preceding embodiment wherein, the polyester polymer includes at least one monocyclic group.
Embodiment 46 is the food or beverage container coating composition of any preceding embodiment, wherein the polyester polymer includes backbone aromatic groups (e.g., one or more backbone aromatic groups present in one or more structural units derived from phthalic acid, terephthalic acid, isophthalic acid, 2,5-furandicarboxylic acid, an anhydride or ester thereof, or combination thereof).
Embodiment 47 is the food or beverage container coating composition of embodiment 45 or 46, wherein the polyester polymer includes at least one backbone alicyclic group (e.g., a backbone alicyclic group present in a structural unit derived from cyclohexanedimethanol (CHDM)).
Embodiment 48 is the food or beverage container coating composition of any preceding embodiment, wherein the polyester polymer is a branched polyester formed from reactants including a branching compound, or wherein the polyester polymer is a non-branched polymer (e.g., linear polymer) formed from linear reactants, or combinations thereof.
Embodiment 49 is the food or beverage container coating composition of any of Embodiments 1 to 48, where the polyester polymer is a linear polymer that is not formed from reactants including a branching compound.
Embodiment 50 is the food or beverage container coating composition of any preceding embodiment, wherein the polyester polymer is formed from reactants including: (i) a polyacid (preferably a diacid), anhydride, dianhydrides, acid/anhydrides, or alkyl ester thereof and (ii) a polyol (preferably a diol).
Embodiment 51 is the food or beverage container coating composition of embodiment 50, wherein the reactants include one or more reactants (i) including an aromatic group.
Embodiment 52 is the food or beverage container coating composition of embodiment 51, wherein the reactants include phthalic acid, terephthalic acid, isophthalic acid, 2,5-furandicarboxylic acid, naphthalene dicarboxylic acid (e.g., 2,6-napthalene dicarboxylic acid), a derivative thereof (e.g., an anhydride or alkyl ester thereof), or a mixture thereof.
Embodiment 53 is the food or beverage container coating composition of embodiments 50 to 52, wherein the reactants include a branching compound having three of more reactive functional groups, preferably three or more reactive functional groups capable of participating in an esterification or transesterification reaction.
Embodiment 54 is the food or beverage container coating composition of embodiments 50 or 53, wherein the branching compound has three reactive functional groups, preferably three reactive functional groups capable of participating in an esterification or transesterification reaction.
Embodiment 55 is the food or beverage container coating composition of embodiments 53 or 54, wherein the reactive functional groups are selected from hydroxyl groups, carboxylic groups, alkyl ester groups, anhydride groups, or a mixture thereof.
Embodiment 56 is the food or beverage container coating composition of any of embodiments 50 or 53 to 55, wherein the branching compound comprises a polyol (e.g., a triol), a polyacid (e.g., a tricarboxylic acid), or a mixture thereof.
Embodiment 57 is the food or beverage container coating composition of any of embodiments 50 or 53 to 56, wherein the branching compound comprises a polyol selected from one or more of glycerol, di-glycerol, trimethylolethane, trimethylolpropane, trimethylolbutane, di-trimethylolethane, di-trimethylolpropane, di-trimethylolbutane, pentarerythritol, or a mixture thereof.
Embodiment 58 is the food or beverage container coating composition of embodiment 57, wherein the branching compound comprises trimethylolpropane.
Embodiment 59 is the food or beverage container coating composition of any of embodiments 50 or 53 to 58, wherein the branching compound comprises trimellitic acid, trimellitic anhydride, an alkyl ester thereof, or a mixture thereof.
Embodiment 60 is the food or beverage container coating composition of any of embodiments 50 or 53 to 59, wherein the polyester polymer includes at least about 0.1, at least about 0.5, at least about 1, at least about 1.5, or at least about 2% by weight of the one or more branching compounds, based on the weight of the one or more branching compounds relative to the total weight of reactants used to make the polyester polymer.
Embodiment 61 is the food or beverage container coating composition of any of embodiments 50 or 53 to 60, wherein the polyester polymer includes less than about 10%, less than about 5%, less than about 3%, or less than about 2% by weight of the one or more branching compounds, based on the weight of the one or more branching compounds relative to the total weight of reactants used to make the polyester polymer.
Embodiment 62 is the food or beverage container coating composition of any preceding embodiment, wherein at least a portion of a distribution of the polyester polymer chains includes at least one primary hydroxyl group.
Embodiment 63 is the food or beverage container coating composition of embodiment 61, wherein the polyester polymer, on average, includes at least one primary hydroxyl group.
Embodiment 64 is the food or beverage container coating composition of any preceding embodiment, wherein at least a portion of a distribution of the polyester polymer chains includes at least two primary hydroxyl groups.
Embodiment 65 is the food or beverage container coating composition of embodiment 64, wherein the polyester polymer, on average, includes at least two primary hydroxyl group.
Embodiment 66 is the food or beverage container coating composition of any preceding embodiment, wherein at least a portion of a distribution of the polyester polymer chains includes at least three primary hydroxyl groups.
Embodiment 67 is the food or beverage container coating composition of any preceding embodiment, wherein the polyester polymer includes, on average, more than 2, more than about 2.2, more than about 2.5, more than about 2.7, more than about 2.9, or more than about 3 hydroxyl groups.
Embodiment 68 is the food or beverage container coating composition of any preceding embodiment, wherein at least 50%, at least 60%, at least 70%, at least 80%, at least 90%, or up to 100% of the hydroxyl groups present on the polyester polymer are primary hydroxyl groups.
Embodiment 69 is the food or beverage container coating composition of any preceding embodiment, wherein the polyester polymer has a polyester backbone that includes a terminal hydroxyl group on at least one terminal end of the backbone.
Embodiment 70 is the food or beverage container coating composition of embodiment 69, wherein the backbone is terminated on each end with a hydroxyl group, and wherein at least one, and preferably both, of the hydroxyl groups are primary hydroxyl groups.
Embodiment 71 is the food or beverage container coating composition of any preceding embodiment, wherein at least about 50 mole percent (mol-%), at least about 60 mol-%, at least about 70 mol-%, at least about 80 mol-%, at least about 95 mol-%, at least about 99 mol %, or up to about 100 mol-% of the one or more polyols used to form the polyester polymer are polyols having primary hydroxyl groups, more preferably polyols that only include primary hydroxyl groups (i.e., no secondary or tertiary hydroxyl groups), even more preferably diols.
Embodiment 72 is the food or beverage container coating composition of any preceding embodiment, wherein the reactants used to make the polyester polymer include, if any, less than about 20, less than about 10, less than about 5, or less than about 1% by weight of polyols having secondary or tertiary hydroxyl groups.
Embodiment 73 is the food or beverage container coating composition of any preceding embodiment, wherein the polyester polymer includes, if any, less than about 5, less than about 2, less than about 1, or less than about 0.1% by weight of tricyclodecanedimethanol, tetramethyl cyclobutanediol, and isosorbide, based on the total weight of reactants used to make the polyester polymer.
Embodiment 74 is the food or beverage container coating composition of any preceding embodiment, wherein the coating composition, based on total resin solids, includes at least about 30, at least about 40, at least about 50, at least about 60, at least about 70, at least about 80, or at least about 90% by weight of the polyester polymer.
Embodiment 75 is the food or beverage container coating composition of any preceding embodiment, wherein the coating composition includes a liquid carrier.
Embodiment 76 is the food or beverage container coating composition of Embodiment 75 wherein the coating composition is a solvent-based coating composition that preferably includes less than 2% by weight of water, if any.
Embodiments 77 is the food or beverage container coating composition of any of embodiments 1 to 74, wherein the coating composition is a powder coating composition.
Embodiment 78 is the food or beverage container coating composition of any preceding embodiment, wherein the coating composition includes a pigment (e.g., an inorganic pigment such as titanium dioxide), preferably in an amount of at least 5% by weight of the coating composition, based on total coating solids.
Embodiment 79 is the food or beverage container coating composition of embodiment 78, wherein the pigment (e.g., an inorganic pigment such as titanium dioxide) is present in the coating composition in an amount of at least about 10, at least about 20, at least about 30, or at least about 40% by weight, based on the total solids of the coating composition.
Embodiment 80 is the food or beverage container coating composition of embodiment 78 or 79, wherein the pigment (e.g., an inorganic pigment such as titanium dioxide) is present in the coating composition in an amount of no greater than about 70, preferably no greater than about 60, and even more preferably no greater than about 50, or no greater than about 45% by weight, based on the total solids weight of the coating composition.
Embodiment 81 is the food or beverage container coating composition of any of embodiments 78 to 80, wherein the pigment is titanium dioxide, barium sulfate, calcium sulfate, zinc sulfide, aluminium power, iron oxide, or combinations thereof, and preferably titanium dioxide.
Embodiment 82 is the food or beverage container coating composition of any preceding embodiment, wherein the coating composition has a viscosity of at least 40 seconds, at least 50 seconds, or at least 60 seconds, at least 70 seconds, or at least 90 seconds at 25° C. (ISO Cup number 6).
Embodiment 83 is the food or beverage container coating composition of any preceding embodiment, wherein the coating composition has a viscosity of up to 150 seconds, up to 125 seconds, up to 100 seconds, up to 95 seconds, or up to 85 seconds at 25° C. (ISO Cup number 6).
Embodiment 84 is the food or beverage container coating composition of any preceding embodiment, wherein the coating composition is an organic-solvent-based, interior white three-piece food or beverage container coating composition.
Embodiment 85 is the food or beverage container coating composition of any preceding embodiment, wherein the polyester polymer does not include any structural segments derived from bisphenol A, bisphenol F, bisphenol S, or any derivatives thereof (e.g., the diglycidyl ether of bisphenol A, the diglycidyl ether of bisphenol F, or the diglycidyl ether of bisphenol S).
Embodiment 86 is the food or beverage container coating composition of any preceding embodiment, wherein the coating composition does not include any structural segments derived from bisphenol A, bisphenol F, bisphenol S, or any derivatives thereof (e.g., the diglycidyl ether of bisphenol A, the diglycidyl ether of bisphenol F, or the diglycidyl ether of bisphenol S).
Embodiment 87 is the food or beverage container coating composition of any preceding embodiment, wherein halogenated materials (e.g., PVC or vinyl chloride) are not used to make the coating composition, although trace detectable amounts may still be present due to, e.g., environmental contamination.
Embodiment 88 is the food or beverage container coating composition of any preceding embodiment, wherein the coating composition includes at least about 25, at least about 30, or at least about 35% by weight of total coating solids.
Embodiment 89 is the food or beverage container coating composition of any preceding embodiment, wherein the coating composition includes up to about 70, up to about 60, or up to about 55% by weight of total coating solids.
Embodiment 90 is the food or beverage container coating composition of any preceding embodiment, wherein the coating composition, when applied on tin-plate steel can stock substrate and baked for 15 minutes in a 200° C. oven to achieve a cured coating having an average dry film weight of about 15 grams per square meter, exhibits an MEK double rub value in the MEK test described herein (using a 1,000 gram weight) of at least about 30, at least about 35, at least about 40, at least about 60, at least about 80, or at least about 100 and, preferably, the coating composition also exhibits such MEK double rub values when using a 2,000 gram weight.
Embodiment 91 is the food or beverage container coating composition of any preceding embodiment, wherein the coating composition, when applied on tin-plate steel can stock substrate and baked for 15 minutes in a 200° C. oven to achieve a cured coating having an average dry film weight of about 15 grams per square meter, passes an electric current (after end formation) of less than about 10 milliamps (mA) when tested as described above in the Plate Aging Test, more preferably less than 5 mA, even more preferably less than 2 mA, after aging for at least about 7 days at 20 to 25° C.
Embodiment 92 is the food or beverage container coating composition of any preceding embodiment, wherein the coating composition, when applied on tin-plate steel can stock substrate and baked for 15 minutes in a 200° C. oven to achieve a cured coating having an average dry film weight of about 15 grams per square meter and stamped without aging into regular food can ends, has an average crack length of less than about 200 microns, preferably less than about 100 microns, more preferably less than about 50 microns, if any, of visible cracks when tested pursuant to the Flow Lines test methods described herein.
Embodiment 93 is the food or beverage container coating composition of any preceding embodiment, wherein the coating composition, when applied on tin-plate steel can stock substrate, stamped into a regular food can end, and baked for 15 minutes in a 200° C. oven to achieve a cured coating having an average dry film weight of about 15 grams per square meter, passes an electric current (after end formation) of less than about 5 milliamps (mA) when tested as described above in the Acid Retort Test, more preferably less than 4 mA, even more preferably less than 2 mA, after subjecting the coated substrate to retort conditions of 1 hour at 130° C. in direct contact with a liquid solution of 3% acetic acid.
Embodiment 94 is the food or beverage container coating composition of any preceding embodiment, wherein the food or beverage container coating composition forms a coating that includes less than 50 ppm extractables, if any, when tested pursuant to the Global Extraction Test.
Embodiment 95 is the food or beverage container coating composition of any preceding embodiment, further comprising one or more optional ingredients including additional crosslinkers (e.g., aminoplasts, phenoplasts, beta-hydroxyalkyl amides, benzoxazines, carbonyl dicaprolactam, oxazolines, or combinations thereof), dyes, pigments, toners, extenders, fillers, lubricants (e.g., Carnauba wax, polyethylene- and polypropylene-type lubricants, Fischer-Tropsch lubricants, or mixtures thereof), defoamers, anticorrosion agents, flow control agents, thixotropic agents, dispersing agent, antioxidants, adhesion promoters, light stabilizers, or mixtures thereof.
Embodiment 96 is a method comprising: applying the food or beverage container coating composition of any of embodiments 1 to 95 to a metal substrate; curing the coating composition on the metal substrate to form a coating; and optionally fabricating the metal substrate having the coating to form a food or beverage container or a portion thereof.
Embodiment 97 is a method comprising: optionally preparing the food or beverage container coating composition of any of embodiments 1 to 95; causing the food or beverage container coating composition of any of embodiments 1 to 95 to be disposed on a food container or a portion thereof, more preferably, an interior portion of the food or beverage container (e.g., on an interior portion of a three-piece food can).
Embodiment 98 is a method of embodiment 96 or 97, wherein the method further includes fabricating the metal substrate having the coating to form a food or beverage container or a portion thereof.
Embodiment 99 is an article comprising a food or beverage container or portion thereof, which comprises: a metal substrate (e.g., a metal sheet such as a steel or tinplate sheet); a coating disposed on at least a portion of the metal substrate, the coating formed from a coating composition of any of embodiments 1 to 95 and/or wherein the coating is applied by the method of any of embodiments 96 to 98.
Embodiment 100 is the method or article of any of embodiments 96 to 99, wherein the food or beverage container or a portion thereof, comprises a twist-off closure, a press-twist closure, or a continuous-thread steel closure.
Embodiment 101 is the method or article of any of embodiments 96 to 100, wherein the food or beverage container or a portion thereof, comprises a food easy open can end.
Embodiment 102 is the method or article of any of embodiments 96 to 101, wherein the food or beverage container or a portion thereof, comprises a three-piece can body or can end.
Embodiment 103 is the method or article of any embodiments 96 to 102, wherein the metal substrate has a thickness of in the range of 125 to 635 microns.
Embodiment 104 is the method or article of any of embodiments 96 to 103, wherein the metal substrate comprises aluminum.
Embodiment 105 is the method or article of any of embodiments 96 to 104, wherein the metal substrate comprises electro tinplated (ETP) steel.
Embodiment 106 is the method or article of any of embodiments 96 to 105, wherein the metal substrate comprises cold-rolled steel.
Embodiment 107 is the method or article of any of embodiments 96 to 106, wherein the coating is a mono-layer coating.
Embodiment 108 is the method or article of any of embodiments 96 to 107, wherein the coating is a multi-layer coating.
Embodiment 109 is the method or article of embodiment 108, wherein a base layer of the multi-layer coating is formed from the coating composition of the present disclosure (e.g., the food or beverage container coating composition of any preceding embodiment).
Embodiment 110 is the method or article of any of embodiments 96 to 109, wherein the coating is, on average, at least 1 micron, typically at least 5 microns, and even more typically at least 10 microns thick.
Embodiment 111 is the method or article of any of embodiments 96 to 110, wherein the coating is, on average, less than 50 microns, more typically less than 40 microns, even more typically less than 30 microns, or less than 20 microns thick.
Embodiment 112 is the article resulting from the method of any of claims 96 to 111.
Embodiment 113 is the coating composition, method, or article of any preceding embodiment, wherein the at least one blocked polyisocyanate crosslinker constitutes at least a majority by weight (i.e., more than 50%) of the total amount of crosslinker present in the coating composition.
Embodiment 114 is the coating composition, method, or article of any preceding embodiment, wherein the coating composition includes, on a weight basis, more of the at least one blocked polyisocyanate than the total amount of phenolic crosslinker present in the coating composition, if the coating composition includes any phenolic crosslinker.
Embodiment 115 is the coating composition, method, or article of any preceding embodiment, wherein the coating composition includes, by weight total solids, less than 10, less than 5, less than 3, less than 2, less than 1, or less than 0.1% by weight, if any, of formaldehyde-containing crosslinker (e.g., phenol-formaldehyde crosslinkers, urea-formaldeyde crosslinkers, melamine-formaldehyde crosslinkers, etc.).
Embodiment 116 is the coating composition, method, or article of any preceding embodiment, wherein the coating composition is not made using any crosslinkers (and preferably any ingredients of any kind) derived from formaldehyde.
Embodiment 117 is the coating composition, method, or article of any preceding embodiment, wherein the coating composition includes, by weight total solids, less than 10, less than 5, less than 3, less than 2, less than 1, or less than 0.1% by weight, if any, of novolak or epoxy novolak resin.
Embodiment 118 is the coating composition, method, or article of any preceding embodiment, wherein coating composition does not include any crosslinkers other than the at least one blocked isocyanate crosslinker.

### Test Methods

Unless indicated otherwise, the following test methods may be utilized. In the following test methods, when metal substrate is specified, tin-plate steel sheet substrate (food can stock) having the following parameters may be used: tin level 2.8, gauge 0.20 mm, passivation 311 and temper TH550. Unless otherwise specified, a coating dry film weight of 15 grams per square meter is used, with suitable cure conditions for producing such coatings being 15 minutes in a 200° C. oven.

### Differential Scanning Calorimetry for Tg

Samples for differential scanning calorimetry (“DSC”) testing are prepared by first applying the liquid resin composition (e.g., a polyester polymer of the present disclosure in solvent) onto aluminum sheet panels. The panels are then baked in a Fisher Isotemp electric oven for 20 minutes at 300° F. (149° C.) to remove volatile materials. After cooling to room temperature, the samples are scraped from the panels, weighed into standard sample pans, and analyzed using the standard DSC heat-cool-heat method. The samples are equilibrated at −60° C., then heated at 20° C. per minute to 200° C., cooled to −60° C., and then heated again at 20° C. per minute to 200° C. Glass transition temperatures are calculated from the thermogram of the last heat cycle. The glass transition is measured at the inflection point of the transition. When measuring the Tg for cured coatings, the DSC can be run in an analogous manner but skipping the removal of volatiles steps.

### Viscosity (Iso 6 at 25° C.) of Coating Composition

Viscosities of coating compositions were measured according to ASTM D 1200 at 90 to 100 seconds using Iso cup No. 6 (a European standard) at 25° C.

### Acid Number (AN) of Resin

The acid number (AN) of a resin may be measured by dissolving a suitable quantity of the resin in a solution of dimethyl formamide (DMF) and methyl ethyl ketone (MEK), then titrating with 0.1 N methanolic KOH and a cresol red/thymol blue or phenolphthalein indicator. Based on the amount of KOH consumed, the acid number is calculated and reported as mg KOH per 1 gram of dry resin.

### Hydroxyl Number of Resin

The hydroxyl value (HN) of a resin may be measured by dissolving a suitable quantity of the resin in Methylene Chloride before mixing the sample for 15-20 minutes with a 4-(dimethylamino) pyridine (DMAP) catalyst solution and a 97% acetic anhydride solution in anhydrous dimethyl formamide (DMF). A solution of DMF and deionized water is then added and the solution is mixed for an additional 15-20 minutes. After supplemental addition of tetrahydrofuran (THF), a titration method with 0.5 N methanolic KOH and a phenolphthalein indicator is used to measure the hydroxyl value of a resin. Based on the amount of KOH consumed as compared to titration of a solution without the resin, the hydroxyl value is calculated and reported as mg KOH per 1 g dry resin.

### Solvent Resistance Test (“MEK Double Rubs”)

The extent of “cure” or crosslinking of a coating is measured as a resistance to solvents, such as methyl ethyl ketone (MEK). This test can be performed as described in ASTM D 5402-93 or as follows: The following equipment is used: an Abrasimeter (e.g., from FRAM CO), a new felt pad, and neat MEK solvent. The sample for evaluation is a coated rectangular tin-plate steel test panel having dimensions of 12 cm by 5 cm. The procedure is as follows: Adapt the abrasimeter by attaching the buffer holder; Set the abrasimeter double rubs counter to zero; Lay the panel coated with the product to be tested on the abrasimeter support; Install the weight on the abrasimeter arm; Soak a new felt pad with the MEK solvent and place it in the test stand; Lower the abrasimeter arm and immediately switch on the double rubs counter; Stop the double rubs counter as soon as the bare metal appears, which is the number of double rubs (i.e., one back-and-forth motion) that is reported. Preferred cured coatings of the present disclosure, when evaluated using a 1,000 gram weight, exhibit an MEK solvent resistance of at least about 30 double rubs, at least about 35, at least about 40, at least about 60, at least about 80, or at least about 100 and, preferably, the cured coatings herein also exhibit such MEK double rub values when using a 2,000 gram weight.

### Porosity Test of Coating

This test provides an indication of the level of flexibility of a coating. Moreover, this test measures the ability of a coating to retain its integrity as it undergoes the formation process necessary to produce a food or beverage can end. In particular, it is a measure of the presence or absence of cracks or fractures in the formed can end.

The end is typically placed on a cup filled with an electrolyte solution. The cup is inverted to expose the surface of the end to the electrolyte solution. The amount of electrical current that passes through the end is then measured. If the coating remains intact (no cracks or fractures) after fabrication, minimal current will pass through the end.

For the present evaluation, standard profile 3-piece tinplate steel food can ends (73 mm diameter) are stamped from coated tinplate steel having the coating to be tested located on the internal side of the sheet.

A test solution is prepared from the following ingredients: 800 grams of deionized water, 4 grams of sodium chloride, 8 grams of potassium ferricyanide (CAS NO 13746-66-2), and 1 gram of AEROSOL OT 75 surfactant. A PECODER 2A porosimeter is used for the evaluation. The porosimeter cell is filled to an appropriate height with the test solution and the formed can end is placed on the porosimeter jar with the coating facing down. A vacuum system linked to the porosimeter is turned on so that the can end sticks on the cell. The porosimeter cell with the can end is then inverted and the electrical current passage, in milliamps, through the coating is measured after four seconds of applied current passing through the coating. This measured current passage is the porosity value.

A coating is considered herein to satisfy the Porosity Test if it passes an electric current (after end formation) of less than about 10 milliamps (mA) when tested as described above, more preferably less than 5 mA, even more preferably less than 2 mA.

### Acid Retort

This test provides an indication of the level of acidic resistance of a coating. For the present evaluation, standard profile 3-piece tinplate steel food can ends (73 mm diameter) are stamped from coated tinplate steel having the coating to be tested located on the internal side of the sheet. To assess the resistance, the coated ends are sterilized in an autoclave for 1 hour at 130° C. in a water solution comprising 3% of acetic acid. Some phenomena are possible: adhesion loss, corrosion, blistering and blush. In the evaluations of the coating examples, porosity of each ends is measured after the retort in acetic acid. A coating is considered herein to satisfy the Acid retort Test if it passes an electric current (after end formation) of less than about 10 milliamps (mA) when tested as described above, more preferably less than 5 mA, even more preferably less than 2 mA.

### Plate Aging

This test provides an indication of the loss of performance (usually related to adhesion and/or flexibility) of an applied coating versus time. Samples are tested after a suitable aging period after coating cure (e.g., after aging for at least about 7 days at 20 to 25° C.). In this test, three successive porosities are measured after sixteen seconds of applied current passing through the coating. Then, a reverse porosity is measured after 16 seconds, that is the wires connecting the cup are inverted so that the current is passing through the coating the other way. A coating is considered herein to satisfy the Plate Aging Porosity Test if: The reverse measure passes an electric current (after end formation) of less than about 10 milliamps (mA) when tested as described above, more preferably less than 5 mA, even more preferably less than 2 mA.

### Flow Lines

The flow lines evaluation measures to total length of cracks, if any on coated tinplate steel food can ends. For the present evaluation, standard profile 3-piece tinplate steel food can end (73 mm diameter are stamped from coated tinplate steel having the coating to be tested located on the internal side of the sheet. Use a well-calibrated press to avoid heterogeneous deformations. Cotton is soaked with red dyestuff based on erythrosine and put on the coating surface of the end. The coated end is left 10 minutes in contact and then washed with water. The presence of cracks on the ends are checked by means of a microscope. The microscope should be focused on the radial slope between the top of the first bead to the onset of the second bead on the can end. Flow lines are measured in the 1000 micron radial slope between these two beads and are radial flow lines highlighted by the red dye. Flow lines are the radial lines in this region of the circumference of the can end and within the end qualitatively richest and most homogeneous in parallel cracks, if any. An electrical microscope (e.g., KEYENCE corporation or equivalent) is used for the evaluation at 100× magnification, or any another magnification suitable to visualize the full width of the descending slope, with crack lines revealed by the red dyestuff. A coating is considered to exhibit worse cracking based on the average length of the cracks visible in the selected area, expressed in microns. The presence of cracks is associated with flexibility failure, and/or limits of the coating to support a deformation. A rating from 0 to 5 is applied, 5 being the best: 5 is no cracks (0 microns); 4 is average crack length of 0 to 200 microns; 3 is average crack length of 200 to 400 microns; 2 is average crack length of 400 to 600 microns; 1 is average crack length of 600 to 800 microns; and 0 is average crack length of greater than 800 microns, ie spanning the entire width of the descending slope beyond the first bead; with the crack length in microns being the aforementioned determined crack length.

### Block Resistance

The block resistance is the ability of a coating to resist sticking to another surface and when it is pressed against that surface for a prolonged period of time. For this evaluation, coated tinplate is cut into 9×9 cm panels with the opposite side being uncoated bare metal. On each panel, place a 32×45 mm black paper sheet (70 g/m² Thalo Japan-Colorbütten schwarz from Schneider-Scherrer AG) in the center of the coated surface. Then, stack the panels such that the coated surface of one sheet is in contact with a paper sheet, where the other face of the paper sheet is in contact with the uncoated bare metal substrate of an upper coated panel. The stack can include from 4 up to 20 total panels. Put the stack on the bottom jaw of a press. The bottom and upper jaws are heated to 35° C. Bring both jaws closer and when they are in contact increase the RAM force to 12,000 pounds. Hold the closed jaws for 3 hours. Remove the stack from the press, and panel by panel, remove each black paper to evaluate blocking. The worse the blocking, the more the black paper sticks on the coated surface. A rating from 0 to 5 is applied, with 5 being the best: 0 means the black paper sticks on the total contact area; 1 means at least 75% of paper remained stuck to the coated surface (i.e., 25% of the paper can be removed); 2 means between 25% and 75% of the paper remained stuck to the coated surface; 3 means, at the most, 25% of the paper remained stuck to the coated surface; 4 means the paper slightly sticks on the coated surface but can be removed without paper adhesion; and 5 means the paper can be removed by itself.

### Global Extraction Test:

The global extraction test is designed to estimate the total amount of mobile material that can potentially migrate out of a coating and into food packed in a coated can. Typically, a coated substrate is subjected to water or solvent blends under a variety of conditions to simulate a given end-use. Acceptable extraction conditions and media can be found in 21 CFR § 175.300, paragraphs (d) and (e), which is incorporated herein by reference. If evaluated herein, the extraction procedure was conducted in accordance with the Food and Drug Administration (FDA) “Preparation of Premarket Submission for Food Contact Substances: Chemistry Recommendations.” (December 2007). The allowable global extraction limit as defined by the FDA regulation is 50 parts per million (ppm).

The single-sided extraction cells are made according to the design found in the Journal of the Association of Official Analytical Chemists, 47(2):387(1964), with minor modifications. The cell is 9 inch×9 inch×0.5 inch with a 6 inch×6 inch open area in the center of the TEFLON spacer. This allows for 36 in² or 72 in² of test article to be exposed to the food simulating solvent. The cell holds 300 mL of food simulating solvent. The ratio of solvent to surface area is then 8.33 mL/in² and 4.16 mL/in² when 36 in² and 72 in² respectively of test article are exposed.

The test articles may consist of 0.0082 inch thick 5182 aluminum alloy panels, pretreated with Permatreat® 1903 (supplied by Chemetall GmbH, Frankfurt am Main, Germany). These panels are coated with the test coating (completely covering at least the 6 inch by 6 inch area required to fit the test cell) to yield a final, dry film thickness of 11 grams per square meter (gsm) following a 10 second curative bake resulting in a 242° C. peak metal temperature (PMT). Two test articles are used per cell for a total surface area of 72 in² per cell. The test articles are extracted in quadruplicate using 10% aqueous ethanol as the food-simulating solvent. The test articles are processed at 121° C. for two hours, and then stored at 40° C. for 238 hours. The test solutions are sampled after 2, 24, 96 and 240 hours. The test article is extracted in quadruplicate using the 10% aqueous ethanol under the conditions listed above.

Each test solution was evaporated to dryness in a pre-weighed 50 mL beaker by heating on a hot plate. Each beaker was dried in a 250° F. (121° C.) oven for a minimum of 30 minutes. The beakers are then placed into a desiccator to cool and then weighed to a constant weight. Constant weight is defined as three successive weighings that differ by no more than 0.00005 g. Solvent blanks using Teflon sheet in extraction cells are similarly exposed to simulant and evaporated to constant weight to correct the test article extractive residue weights for extractive residue added by the solvent itself. Two solvent blanks are extracted at each time point and the average weight is used for correction.

Total nonvolatile extractives are calculated as follows: Ex=e/s and wherein the variable “Ex” refers to the extractive residues (mg/in²); “e” refers to extractives per replicate tested (mg); and “s” refers to the area extracted (in²). Preferred coatings give global extraction results at all of the above-tested time periods of less than 50 ppm, more preferred results of less than 10 ppm, even more preferred results of less than 1 ppm. Most preferably, the global extraction results are optimally non-detectable.

### EXAMPLES

These Examples are merely for illustrative purposes and are not meant to be overly limiting on the scope of the appended embodiments. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the embodiments, each numerical parameter should at least be construed in light of the number of reported significant digits and by applying ordinary rounding techniques. Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

### Example 1

A coating composition of the present disclosure was prepared using the ingredients in Table 1 below. The polyester resin of this coating composition was a branched polyester polymer. Ingredients 1 and 2 were combined using high stir dispersion (2×5 minutes 2400 RPM) to form a TiO₂ dispersion (North Jauge >9). Then each of charges 3 through 9 were incorporated one by one into the TiO₂ dispersion to form premix 1 (shown as ingredient 10). Then ingredients 11 and 12 were incorporated one-by-one into premix 1, followed by stirring for 5 minutes at 1,500 RPM.

TABLE 1

| | | | Weight |
|---|---|---|---|
| Ingredient | | Supplier | Percent |
| 1 | SKYBON ES770 polyester¹ | SK | 28.38 |
| | dissolved 40% in solvent | Chemicals | |
| | mixture | | |
| 2 | Kronos 2064 titanium dioxide | KRONOS, | 21.02 |
| | pigment | INC. | |
| 3 | SKYBON ES770 polyester¹ | SK | 28.87 |
| | dissolved 40% in solvent | Chemicals | |
| | mixture | | |
| 4 | Hydrosol A170 solvent naphtha | DHC Solvent | 4.40 |
| | | Chemie | |
| 5 | Diethylene Glycol Butyl Ether | | 5.25 |
| 6 | Lanco Glidd 3520 PTFE modified | Lubrizol | 4.31 |
| | polyethylene wax | | |
| 7 | BYK 310 (polyester modified | BYK | 0.18 |
| | PDMS) - diluted 20% in solvent | | |
| 8 | BYK LP D 21399 additive - | BYK | 0.44 |
| | diluted 50% in solvent | | |
| 9 | Hydrosol A170 solvent naptha | DHC Solvent | 0.85 |
| | | Chemie | |
| 10 | Premix 1 | | |
| 11 | Desmodur BL 3272 MPA (HDI)² | Covestro | 6.3 |
| 12 | Fascat 9102 catalyst (Monobutyltin | PMC Group | 0.015 |
| | tris(2-ethylhexanoate)) | | |

¹According to manufacturer's literature, the SKYBON ES770 polyester is a branched polyester polymer dissolved in an organic solvent and having an IV (dl/g) of 0.48, an Mn of 16,000, a Tg of 68° C., a hydroxy number of 6-10 mg KOH/g, and an acid number of less than 3 mg KOH/g.
²According to manufacturer's literature, the Desmodur BL 3272 is a blocked aliphatic polyisocyanate based only on HDI, blocked with ε-caprolactam, and believed to have the structure of Formula 1 above with at least about 95% of isocyanate groups blocked, and having a number average molecular weight of less than about 2,000 g/mol.

The coating composition was thermally cured on suitable metal food container substrate and tested for various coating properties pertinent to interior food container coatings (e.g., for interior 3-piece white food container coatings). The coating showed very good powder adhesion when tested relative to an industry standard side seam powder coating composition for three-piece food cans. The coating also showed very good porosity results when fabricated after plate aging (e.g., after at least 7 days of aging). The coating also showed very good crack resistance in other crack evaluations (e.g., visual observation after dying to visual cracks), and an improved level of crack resistance relative to a commercial polyester 3-piece interior white food container coating.

### Example 2

Linear hydroxyl-functional polyester polymers of table 2 below were prepared as follows: ingredients 1 through 5 were added to a suitable reactor and heated to about 220° C. under nitrogen. At about 100° C., the catalyst (ingredient 9) was added along with any antifoam. The mixture was slowly heated and then held at about 220° C. until an acid number of less than 2 was achieved. Next, ingredients 6, 7, and 8 were added to the reactor and heated to about 240° C. under nitrogen. The mixture was then cooled to about 180° C. Next, the reactor was set-up for distillation with ingredients 10 or 11 added to the mixture at about 170° C. to about 190° C. The reactor was then heated to about 240° C. for distillation, and when azeotropic distillation started, samples were taken every 30 minutes until an acid number of less than 3 was achieved. The mixture was then cooled and thinned by adding ingredients 12 to 16. Properties of each resin are also shown in Table 2.

TABLE 2

| | | Linear | Linear | Linear |
|---|---|---|---|---|
| | | Polyester A | Polyester B | Polyester C |
| 1 | Neopentyglycol | 13.72% | 13.06% | 9.61% |
| 2 | 1,6-Hexanediol | 3.06% | 2.89% | 5.74% |
| 3 | Monoethyleneglycol | 2.08% | 1.96% | 2.02% |
| 4 | 1,4-Cyclohexane- | 5.34% | 5.04% | 5.35% |
| | dimethanol | | | |
| 5 | Terephthalic acid | 11.69% | 11.35% | 11.27% |
| 6 | Isophtalic Acid | 23.73% | 23.05% | 17.54% |
| 7 | Sebacic Acid | — | — | 5.78% |
| 8 | Radiacid 960 | 3.19% | — | — |
| 9 | Tyzor TE (catalysor) | 0.07% | 0.06% | 0.06% |
| 10 | Solvesso 100 | — | — | 4.1% |
| 11 | Xylene | 2.9% | 2.65% | — |
| 12 | Xylene | 11.44% | 10.37% | 13.0% |
| 13 | Solvesso 100 | 9.19% | 8.32% | 13.3% |
| 14 | RPDE | 7.16% | 6.49% | 6.5% |
| 15 | BGA | 7.16% | 6.49% | 6.5% |
| 16 | dowanol PMA | 7.16% | 15.69% | 6.5% |
| | TOTAL* | 100.0 | 100.0 | 100.0 |
| | Peak Molecular | 27,914 | 24,655 | 31,189 |
| | Weight (Mp) | | | |
| | Tg © | 48° C. | 59° C. | 16° C. |
| | Hydroxyl Number | 21 | 22 | 20 |
| | Acid Number | <3 | <3 | <3 |

*Reflects water lost by distillation

### Comparative Example 3

A comparative coating composition was prepared using the ingredients in Table 3 below similar to the methods of Example 1. The polyester resin of this Example was Linear Polyester C of Example 2. Ingredients 1 and 2 were combined using high stir dispersion (2×5 minutes 2400 RPM) to form a TiO₂ dispersion (North Jauge >9). Then each of charges 3 through 9 were incorporated one by one into the TiO₂ dispersion to form premix 1 (shown as row 10). Then ingredients 11 and 12 were incorporated one-by-one into premix 1, followed by stirring for 5 minutes at 1,500 RPM.

TABLE 3

| Ingredient | | Supplier | % |
|---|---|---|---|
| 1 | Linear polyester C (Example 2) | | 29.1 |
| 2 | Kronos 2064 titanium | KRONOS, | 29.1 |
| | dioxide pigment | INC. | |
| 3 | Linear polyester C (Example 2) | | 20.0 |
| 4 | Hydrosol A170 solvent naphtha | DHC Solvent | 4.0 |
| | | Chemie GMBH | |
| 5 | Diethylene Glycol Butyl Ether | aq | 4.0 |
| 6 | Lanco Glidd 3520 PTFE modified | Lubrizol | 4.7 |
| | polyethylene wax dispersion | | |
| 7 | BYK 310 (polyester modified | BYK | 0.19 |
| | PDMS) - diluted 20% in solvent | | |
| 8 | BYK LPD 21399 additive - | BYK | 0.48 |
| | diluted 50% in solvent | | |
| 9 | Diethylene Glycol Butyl Ether | | 2.72 |
| 10 | Premix 1 | | |
| 11 | Desmodur BL 2078/2 (IPDI) | Covestro | 5.67 |
| 12 | Fascat 9102 catalyst (Monobutyltin | PMC Group | 0.01 |
| | tris(2-ethylhexanoate)) | | |

### Comparative Example 4

Another comparative coating composition was prepared using the ingredients in Table 4 below similar to the methods of Example 1. The polyester resin of this Example was a branched polyester polymer (Skybon ES770, SK Chemicals). Ingredients 1 and 2 were combined using high stir dispersion (2×5 minutes 2400 RPM) to form a TiO₂ dispersion (North Jauge >9). Then each of charges 3 through 9 were incorporated one by one into the TiO₂ dispersion to form premix 1 (shown as row 11). Then ingredients 12 and 13 were incorporated one-by-one into premix 1, followed by stirring for 5 minutes at 1,500 RPM.

TABLE 3

| Ingredient | | Supplier | % |
|---|---|---|---|
| 1 | SKYBON ES770 polyester¹ | SK | 25.3 |
| | dissolved 40% in solvent | Chemicals | |
| | mixture | | |
| 2 | Kronos 2064 titanium dioxide | KRONOS, | 25.3 |
| | pigment | INC. | |
| 3 | SKYBON ES770 polyester¹ | SK | 21.5 |
| | dissolved 40% in solvent | Chemicals | |
| | mixture | | |
| 4 | Hydrosol A170 solvent naphtha | DHC Solvent | 8.0 |
| | | Chemie GMBH | |
| 5 | Diethylene Glycol Butyl Ether | | 8.0 |
| 6 | Lanco Glidd 3520 PTFE modified | Lubrizol | 4.7 |
| | polyethylene wax dispersion | | |
| 7 | BYK 310 (Polyester modified | BYK | 0.19 |
| | PDMS) - diluted 20% in solvent | | |
| 8 | BYK LPD 21399 - | BYK | 0.5 |
| | diluted 50% in solvent | | |
| 9 | Diethylene Glycol Butyl Ether | | 1.2 |
| 10 | Hydrosol A170 solvent naptha | DHC Solvent | 1.2 |
| | | Chemie GMbH | |
| 11 | Premix 1 | | |
| 12 | Desmodur BL2078/2 (IPDI trimer) | Covestro | 4.16 |
| 13 | Fascat 9102 catalyst (Monobutyltin | PMC Group | 0.01 |
| | tris(2-ethylhexanoate)) | | |

¹According to manufacturer's literature, the SKYBON ES770 polyester is a branched polyester polymer in organic solvent and having an IV (dl/g) of 0.48, an Mn of 16,000, a Tg of 68° C., a hydroxy number of 6-10 mg KOH/g, and an acid number of less than 3 mg KOH/g.

### Comparative Example 5

Another comparative coating composition was prepared using the ingredients in Table 5 below similar to the methods of Example 1. The polyester resin of this Example was Linear Polyester polymer C of Example 2. Ingredients 1 and 2 were combined using high stir dispersion (2×5 minutes 2400 RPM) to form a TiO₂ dispersion (North Jauge >9). Then each of charges 3 through 9 were incorporated one by one into the TiO₂ dispersion to form premix 1 (shown as row 10). Then ingredients 11 and 12 were incorporated one-by-one into premix 1, followed by stirring for 5 minutes at 1,500 RPM.

TABLE 5

| Ingredient | | Supplier | % |
|---|---|---|---|
| 1 | Linear polyester polymer | | 28.4 |
| | C (Example 2) | | |
| 2 | Kronos 2064 titanium dioxide | KRONOS, | 28.4 |
| | pigment | INC. | |
| 3 | Linear polyester polymer | | 14.5 |
| | C (Example 2) | | |
| 4 | Hydrosol A170 solvent naphtha | DHC Solvent | 6.5 |
| | | Chemie GMBH | |
| 5 | Diethylene Glycol Butyl Ether | | 6.5 |
| 6 | Lanco Glidd 3520 PTFE modified | Lubrizol | 5.5 |
| | polyethylene wax dispersion | | |
| 7 | BYK 310 (polyester modified | BYK | 0.22 |
| | PDMS) - diluted 20% in solvent | | |
| 8 | BYK LPD 21399 additive - | BYK | 0.55 |
| | diluted 50% in solvent | | |
| 9 | Diethylene Glycol Butyl Ether | | 3.16 |
| 10 | Premix 1 | | |
| 11 | Desmodur BL 3272 (HDI)¹ | Covestro | 6.3 |
| 12 | Fascat 9102 catalyst (Monobutyltin | PMC Group | 0.02 |
| | tris(2-ethylhexanoate)) | | |

¹According to manufacturer's literature, the Desmodur BL 3272 is a blocked aliphatic polyisocyanate based only on HDI, blocked with ε-caprolactam, and believed to have the structure of Formula 1 above with at least about 95% of isocyanate groups blocked, and having a number average molecular weight of less than about 2,000 g/mol.

### Example 6

Another coating composition of the present disclosure was prepared using the ingredients in Table 6 below similar to the methods of Example 1. The polyester resin of this Example was a branched polyester polymer (Skybon ES770, SK Chemicals). Ingredients 1 and 2 were combined using high stir dispersion (2×5 minutes 2400 RPM) to form a TiO₂ dispersion (North Jauge >9). Then each of charges 3 through 9 were incorporated one by one into the TiO₂ dispersion to form premix 1 (shown as row 11). Then ingredients 12 and 13 were incorporated one-by-one into premix 1, followed by stirring for 5 minutes at 1,500 RPM.

TABLE 6

| Ingredient | | Supplier | % |
|---|---|---|---|
| 1 | SKYBON ES770 polyester | SK | 24.5 |
| | dissolved in organic solvent¹ | Chemicals | |
| 2 | Kronos 2064 titanium dioxide | KRONOS, | 24.5 |
| | pigment | INC. | |
| 3 | SKYBON ES770 polyester | SK | 20.9 |
| | dissolved in organic solvent¹ | Chemicals | |
| 4 | Hydrosol A170 solvent naphtha | DHC Solvent | 8.0 |
| | | Chemie | |
| 5 | Diethylene Glycol Butyl Ether | | 8.0 |
| 6 | Lanco Glidd 3520 PTFE modified | Lubrizol | 4.6 |
| | polyethylene wax | | |
| 7 | BYK 310 (Polyester modified | BYK | 0.2 |
| | PDMS) - diluted 20% in solvent | | |
| 8 | BYK LPD 21399 - | BYK | 0.5 |
| | diluted 50% in solvent | | |
| 9 | Diethylene Glycol Butyl Ether | | 1.8 |
| 10 | Hydrosol A170 solvent naptha | DHC Solvent | 1.8 |
| | | Chemie | |
| 11 | Premix 1 | | |
| 12 | Desmodur BL 3272 (HDI)² | Covestro | 5.2 |
| 13 | Fascat 9102 catalyst (Monobutyltin | PMC Group | 0.01 |
| | tris(2-ethylhexanoate)) | | |

¹According to manufacturer's literature, the SKYBON ES770 polyester is a branched polyester polymer in organic solvent and having an IV (dl/g) of 0.48, an Mn of 16,000, a Tg of 68° C., a hydroxy number of 6-10 mg KOH/g, and an acid number of less than 3 mg KOH/g.
²According to manufacturer's literature, the Desmodur BL 3272 is a blocked aliphatic polyisocyanate based only on HDI, blocked with ε-caprolactam, and believed to have the structure of Formula 1 above with at least about 95% of isocyanate groups blocked, and having a number average molecular weight of less than about 2,000 g/mol.

### Example 7

Another coating composition of the present disclosure was prepared using the ingredients in Table 7 below similar to the methods of Example 1. The polyester resin of this Example was Linear Polyester polymer B of Example 2. Ingredients 1 and 2 were combined using high stir dispersion (2×5 minutes 2400 RPM) to form a TiO₂ dispersion (North Jauge >9). Then each of charges 3 through 9 were incorporated one by one into the TiO₂ dispersion to form premix 1 (shown as row 10). Then ingredients 11 and 12 were incorporated one-by-one into premix 1, followed by stirring for 5 minutes at 1,500 RPM

TABLE 7

| Ingredient | | Supplier | % |
|---|---|---|---|
| 1 | Linear polyester polymer | | 23.4 |
| | B (Example 2) | | |
| 2 | Kronos 2064 titanium dioxide | KRONOS, | 23.4 |
| | pigment | INC. | |
| 3 | Linear polyester polymer | | 25.5 |
| | B (Example 2) | | |
| 4 | Hydrosol A170 solvent naphtha | DHC Solvent | 7.8 |
| | | CHemie GMBH | |
| 5 | Diethylene Glycol Butyl Ether | | 7.8 |
| 6 | Lanco Glidd 3520 PTFE modified | Lubrizol | 4.8 |
| | polyethylene wax dispersion | | |
| 7 | BYK 310 (polyester modified | BYK | 0.19 |
| | PDMS) - diluted 20% in solvent | | |
| 8 | BYK LPD 21399 additive - | BYK | 0.49 |
| | diluted 50% in solvent | | |
| 9 | Diethylene Glycol Butyl Ether | | — |
| 10 | Premix 1 | | |
| 11 | Desmodur BL 3272 (HDI)¹ | Covestro | 6.8 |
| 12 | Fascat 9102 catalyst (Monobutyltin | PMC Group | 0.02 |
| | tris(2-ethylhexanoate)) | | |

¹According to manufacturer's literature, the Desmodur BL 3272 is a blocked aliphatic polyisocyanate based only on HDI, blocked with ε-caprolactam, and believed to have the structure of Formula 1 above with at least about 95% of isocyanate groups blocked, and having a number average molecular weight of less than about 2,000 g/mol.

### Comparative Example 8

Another comparative coating composition was prepared using the ingredients in Table 8 below similar to the methods of Example 1. The polyester resin of this Example was Linear Polyester polymer A of Example 2. Ingredients 1 and 2 were combined using high stir dispersion (2×5 minutes 2400 RPM) to form a TiO₂ dispersion (North Jauge >9). Then each of charges 3 through 9 were incorporated one by one into the TiO₂ dispersion to form premix 1 (shown as row 10). Then ingredients 11 and 12 were incorporated one-by-one into premix 1, followed by stirring for 5 minutes at 1,500 RPM.

TABLE 8

| Ingredient | | Supplier | % |
|---|---|---|---|
| 1 | Linear polyester polymer | | 20.5 |
| | A (Example 2) | | |
| 2 | Kronos 2064 titanium dioxide | KRONOS, | 20.5 |
| | pigment | INC. | |
| 3 | Linear polyester polymer | | 19.8 |
| | A (Example 2) | | |
| 4 | Hydrosol A170 solvent naphtha | DHC Solvent | 13.3 |
| | | CHemie GMBH | |
| 5 | Diethylene Glycol Butyl Ether | | 13.3 |
| 6 | Lanco Glidd 3520 PTFE modified | Lubrizol | 4.2 |
| | polyethylene wax dispersion | | |
| 7 | BYK 310 (polyester modified | BYK | 0.17 |
| | PDMS) - diluted 20% in solvent | | |
| 8 | BYK LPD 21399 additive - | BYK | 0.43 |
| | diluted 50% in solvent | | |
| 9 | Diethylene Glycol Butyl Ether | | — |
| 10 | Premix 1 | | |
| 11 | Desmodur BL 2078/2 (IPDI trimer) | Covestro | 7.72 |
| 12 | Fascat 9102 catalyst (Monobutyltin | PMC Group | 0.013 |
| | tris(2-ethylhexanoate)) | | |

### Example 9

Another coating composition of the present disclosure was prepared using the ingredients in Table 9 below similar to the methods of Example 1. The polyester resin of this Example was Linear Polyester polymer A of Example 2. Ingredients 1 and 2 were combined using high stir dispersion (2×5 minutes 2400 RPM) to form a TiO₂ dispersion (North Jauge >9). Then each of charges 3 through 9 were incorporated one by one into the TiO₂ dispersion to form premix 1 (shown as row 10). Then ingredients 11 and 12 were incorporated one-by-one into premix 1, followed by stirring for 5 minutes at 1,500 RPM

TABLE 5

| Ingredient | | Supplier | % |
|---|---|---|---|
| 1 | Linear polyester polymer | | 20.8 |
| | A (Example 2) | | |
| 2 | Kronos 2064 titanium dioxide | KRONOS, | 20.8 |
| | pigment | INC. | |
| 3 | Linear polyester polymer | | 20.0 |
| | A (Example 2) | | |
| 4 | Hydrosol A170 solvent naphtha | DHC Solvent | 13.4 |
| | | CHemie GMBH | |
| 5 | Diethylene Glycol Butyl Ether | | 13.4 |
| 6 | Lanco Glidd 3520 PTFE modified | Lubrizol | 4.2 |
| | polyethylene wax dispersion | | |
| 7 | BYK 310 (polyester modified | BYK | 0.17 |
| | PDMS) - diluted 20% in solvent | | |
| 8 | BYK LPD 21399 additive - | BYK | 0.43 |
| | diluted 50% in solvent | | |
| 9 | Diethylene Glycol Butyl Ether | | — |
| 10 | Premix 1 | | |
| 11 | Desmodur BL 3272 (HDI)¹ | Covestro | 6.8 |
| 12 | Fascat 9102 catalyst (Monobutyltin | PMC Group | 0.013 |
| | tris(2-ethylhexanoate)) | | |

¹According to manufacturer's literature, the Desmodur BL 3272 is a blocked aliphatic polyisocyanate based only on HDI, blocked with ε-caprolactam, and believed to have the structure of Formula 1 above with at least about 95% of isocyanate groups blocked, and having a number average molecular weight of less than about 2,000 g/mol.

### Example 10

The coating compositions of EXAMPLES 3 to 9 were each thermally cured on tinplate, tin level 2.8, gauge 0.20 mm, and temper TH550. Each coating composition was applied at about 15 grams per square meter and baked for about 10 minutes at about 200° C. the baked coated were each tested for various coating properties pertinent to interior food container coatings (e.g., for interior 3-piece white food or beverage container coatings). The coatings were evaluated for cure (MEK double rubs), presence of flow lines, porosity after plate aging, porosity after acid retort, and/or blocking resistance. Results are show in Table 10 below.

TABLE 10
Performance (unacceptable results shown by underlining)

| | COMP. | COMP. | COMP. | | | COMP. | |
|---|---|---|---|---|---|---|---|
| | EX 3 | EX 4 | EX 5 | EX 6 | EX 7 | EX 8 | EX 9 |
| Polyester Resin | Linear | Branched | Linear | Branched | Linear | Linear | Linear |
| Tg of Polyester Resin | 16° C. | 68° C. | 16° C. | 68° C. | 59° C. | 48° C. | 48° C. |
| Isocyanate | IPDI | IPDI | HDI | HDI | HDI | IPDI | HDI |
| MEK double rub | 55 | 30 | >100 | >100 | — | — | — |
| Flow lines (avg crack length in microns) | 0 | 546 | 0 | 0 | 0 | 0 | 0 |
| Plate Aging after 3 days at 20-25° C. (mA) | 0.6 | 165 | 1.6 | 7.8 | 2.0 | 97.6 | 0.7 |
| Porosity after retort in 3% acetic acid (mA) | 1.3 | 5.3 | 1.3 | 3 | 1.1 | 3.5 | 1.5 |
| Block resistance | 1 | 5 | 0 | 5 | — | — | — |

Comparative Examples 3, 4, and 5 were comparative compositions as Example 3 was unacceptable for poor block resistance, Example 4 was unacceptable for a high length of total cracks and poor plate aging, and Example 5 was unacceptable for poor block resistance. Examples 6 and 7 were inventive composition having the selected polyester resin and blocked polyisocyanate and achieving good flow line performance, good plate aging performance, and good porosity performance after retort. Example 8 was a comparative example that exhibited poor plate aging. Example 9 was also an inventive sample exhibiting acceptable flow lines, plate aging, and porosity. While not intending to be bound by theory, it is believed the superior balance of properties for the inventive coating composition examples was attributable to the use of a suitable hydroxyl-functional polyester polymer having a Tg of at least 20° C. in combination with a suitable blocked polyisocyante crosslinker having blocked primary isocyanate groups. Table 10 (and FIGS. 1 and 2) shows the advantages of using a blocked isocyanate crosslinker obtained from HDI in combination with a linear or branched hydroxyl-functional polyester having a glass transition temperature (Tg) of at least about 20° C. as compared to compositions having either IPDI-based crosslinkers or polyester resins with a Tg of less than about 20° C.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A food or beverage container coating composition suitable for coating, at least a portion of, an inner side of a food container, the food or beverage container coating composition comprising:
a hydroxyl-functional polyester polymer, wherein the hydroxyl-functional polyester polymer has a glass transition temperature (Tg) of 20° C. or higher, as determined by differential scanning calorimetry (DSC); and
at least one blocked polyisocyanate crosslinker, wherein
(i) the blocked polyisocyanate crosslinker has, on average, at least two primary isocyanate groups per molecule; and/or
(ii) the blocked polyisocyanate crosslinker has, on average, more than 50 mole percent of the isocyanate groups present on the at least one blocked polyisocyanate crosslinker being primary isocyanate groups; and/or
(iii) the blocked polyisocyanate crosslinker is a reaction product of ingredients including a diisocyanate having two primary isocyanate groups.

2. (canceled)

3. The food or beverage container coating composition of claim 1, wherein the at least one blocked polyisocyanate crosslinker includes three or more isocyanate groups.

4. The food or beverage container coating composition of claim 3, wherein the at least one blocked polyisocyanate crosslinker is a reaction product of ingredients including one or more of hexamethylene diisocyanate (HDI), 1,4-diisocyanatobutane, pentamethylene diisocyanate, 1,12-diisocyanatododecaneor, or one or more other diisocyanates selected from OCN—CH₂—R—CH₂—NCO wherein R is any branched or unbranched hydrocarbon chain.

5. The food or beverage container coating composition of claim 1, wherein the at least one blocked polyisocyanate crosslinker is a reaction product of ingredients including hexamethylene diisocyanate (HDI).

6. The food or beverage container coating composition of claim 5, wherein the at least one blocked polyisocyanate crosslinker comprises an isocyanate trimer.

7. The food or beverage container coating composition of claim 1, wherein the at least one blocked polyisocyanate crosslinker comprises a blocked hexamethylene diisocyanate trimer.

8. The food or beverage container coating composition of claim 1, wherein the at least one blocked polyisocyanate crosslinker is prepared using a cyclic ester, preferably a lactone such as ε-caprolactam as the only blocking agent, and wherein at least about 95% of the isocyanate groups are blocked with a cyclic ester, preferably a lactone such as ε-caprolactam.

9. The food or beverage container coating composition of claim 1, wherein the at least one blocked polyisocyanate crosslinker has a number average molecular weight (Mn) of less than about 2,000 g/mol.

10. The food or beverage container coating composition of claim 1, wherein the coating composition, based on total solids weight, includes about 1% to less than about 40% by weight of the at least one blocked polyisocyanate crosslinker.

11. (canceled)

12. (canceled)

13. The food or beverage container coating composition of any claim, 1 wherein the polyester polymer has a hydroxyl value of more than about 5 to less than about 50 mg KOH/g resin.

14. The food or beverage container coating composition of claim 1, wherein the polyester polymer has an acid value, if any, of less than 20 mg KOH/g resin.

15. The food or beverage container coating composition of claim 1, wherein the polyester polymer has a glass transition temperature (Tg) of about 30° C. to less than about 120° C. as determined by differential scanning calorimetry (DSC).

16. (canceled)

17. (canceled)

18. (canceled)

19. (canceled)

20. (canceled)

21. The food or beverage container coating composition of claim 1, wherein the coating composition is a solvent-based coating composition that includes less than 2% by weight of water, if any, and, based on total resin solids, includes at least about 30% by weight of the polyester polymer.

22. (canceled)

23. (canceled)

24. The food or beverage container coating composition of claim 1, wherein the coating composition is an organic-solvent-based, interior white three-piece food or beverage container coating composition.

25. (canceled)

26. The food or beverage container coating composition of pfeeeding claim 1, wherein the at least one blocked polyisocyanate crosslinker constitutes more than 50% by weight of the total amount of crosslinker present in the coating composition.

27. The food or beverage container coating composition of claim 26, wherein the coating composition includes an additional blocked isocyanate crosslinker that is a reaction product of IPDI.

28. (canceled)

29. (canceled)

30. The food or beverage container coating composition of any claim 1, wherein the coating composition, when applied on tin-plate steel can stock substrate and baked for 15 minutes in a 200° C. oven to achieve a cured coating having an average dry film weight of about 15 grams per square meter, passes an electric current (after end formation) of less than about 10 milliamps (mA), after aging for 3 days at 20 to 25° C.

31. The food or beverage container coating composition of claim 30, wherein the coating composition, when applied on tin-plate steel can stock substrate and baked for 15 minutes in a 200° C. oven to achieve a cured coating having an average dry film weight of about 15 grams per square meter and stamped without aging into regular food can ends, has an average crack length of less than about 200 microns, if any, of visible cracks.

32. The food or beverage container coating composition of claim 31, wherein the coating composition, when applied on tin-plate steel can stock substrate formed into a can end and baked for 15 minutes in a 200° C. oven to achieve a cured coating having an average dry film weight of about 15 grams per square meter, passes an electric current (after end formation) of less than about 10 milliamps (mA) after subjecting the coated substrate to retort conditions of 1 hour at 130° C. in direct contact with a liquid solution of 3% acetic acid.

33. (canceled)

34. A method comprising:
applying the food or beverage container coating composition of claim 1 to a metal substrate;
curing the coating composition on the metal substrate to form a coating; and
optionally fabricating the metal substrate having the coating to form a food or beverage container or a portion thereof.

35. A method comprising:
optionally preparing the food or beverage container coating composition of claim 1;
causing the food or beverage container coating composition of claim 1 to be disposed on a food container or a portion thereof.

36. An article comprising a food or beverage container or portion thereof, which comprises:
a metal substrate;
a coating disposed on at least a portion of the metal substrate, the coating formed from a coating composition of claim 1.

37. The food or beverage container coating composition of claim 1, wherein at least about 50 mole percent (mol-%) of the one or more polyols used to form the polyester polymer are polyols having primary hydroxyl groups.
